(19) United States
(12) Patent Application Publication
(10) Pub. No.: US 2023/0282890 A1
(43) Pub. Date: Sep. 7, 2023

(54) Electrode Stack Assembly for a Metal Hydrogen Battery

(71) Applicant: EnerVenue, Inc, Fremont, CA (US)

(72) Inventors: Jingyi Zhu, Santa Clara, CA (US); Nelson Dichter, Oakland, CA (US); Ge Zu, San Jose, CA (US); Yingying Wu, Sunnyvale, CA (US); Majid Keshavarz, Pleasanton, CA (US)

(21) Appl. No.: 17/687,527

(22) Filed: Mar. 4, 2022

(51) Int. Cl. H01M 10/34; H01M 10/04

(52) U.S. Cl. CPC H01M 10/345; H01M 10/0468; H01M 10/0472

(57) ABSTRACT

A metal hydrogen battery is presented. The metal hydrogen batter includes an electrode stack, the electrode stack including alternating anode assemblies and cathode assemblies, the anode assemblies and cathode assemblies separated by a separator, each of the anode assemblies including at least one anode layer connected to an anode bus, each of the cathode assemblies including at least one cathode layer connected to a cathode bus, wherein each of the anode buses are electrically and mechanically attached to form an anode conductor, and wherein each of the cathode buses are electrically and mechanically attached to form a cathode conductor. The electrode stack is positioned in a pressure vessel, the pressure vessel including a side wall, a cathode end plate, and an anode end plate. Finally, an electrolyte is contained within the pressure vessel.

### TECHNICAL FIELD

Embodiments of the present invention are related to metal-hydrogen batteries and, in particular, to configurations of metal-hydrogen batteries.

### DISCUSSION OF RELATED ART

For renewable energy resources such as wind and solar to be competitive with traditional fossil fuels, large-scale energy storage systems are needed to mitigate their intrinsic intermittency. To build a large-scale energy storage, the cost and long-term lifetime are the utmost considerations. Currently, pumped-hydroelectric storage dominates the grid energy storage market because it is an inexpensive way to store large quantities of energy over a long period of time (about 50 years), but it is constrained by the lack of suitable sites and the environmental footprint. Other technologies such as compressed air and flywheel energy storage show some different advantages, but their relatively low efficiency and high cost should be significantly improved for grid storage. Rechargeable batteries offer great opportunities to target low-cost, high capacity and highly reliable systems for large-scale energy storage. Improving reliability of rechargeable batteries has become an important issue to realize a large-scale energy storage.

Consequently, there is a need for better metal-hydrogen battery configurations.

### SUMMARY

In accordance with embodiments of this disclosure a metal hydrogen battery is presented. Some embodiments of a metal hydrogen battery include an electrode stack, the electrode stack including alternating anode assemblies and cathode assemblies, the anode assemblies and cathode assemblies separated by a separator, each of the anode assemblies including at least one anode layer connected to an anode bus, each of the cathode assemblies including at least one cathode layer connected to a cathode bus, wherein each of the anode buses are electrically and mechanically attached to form an anode conductor, and wherein each of the cathode buses are electrically and mechanically attached to form a cathode conductor; a pressure vessel, the pressure vessel including a side wall, a cathode end plate, and an anode end plate, the electrode stack inserted within the pressure vessel; and an electrolyte contained within the electrode stack.

A method of forming a metal hydrogen battery according to some embodiments of the present disclosure includes preassembling components of the metal hydrogen battery by assembling a plurality of cathode assemblies, each cathode assembly having a cathode bus bar attached to one or more cathode material layers, assembling a plurality of anode assemblies, each anode assembly having an anode bus bar coupled to one or more anode material layers, forming separators from one or more separator layers, forming frame inner portions and frame outer portions, at least one of the frame inner portion and frame outer portion including fingers that connect the frame inner portion and the frame outer portion, assembling a cathode feedthrough assembly that includes a bridge welded to a cathode feedthrough conductor, assembling a cathode vessel assembly that include a cathode end cap, a feedthrough connected to the cathode end cap, a fill tube connected to the cathode end cap, and a vessel sidewall attached to the cathode end cap, wherein the feedthrough includes a body and an insulator, and preparing an electrolyte. After the components have been preassembled, the metal hydrogen battery can be formed by stacking the frame inner portion, the frame outer portion, separators, anode assemblies, and cathode assemblies in a jig to capture the electrodes between the frame inner portion and the frame outer portion; pressing the electrodes, the frame inner portion, and the frame outer portion in the jig; forming an electrode stack by, while pressure is applied, attaching the frame inner portion to the frame outer portion with the fingers to form a frame, attaching the anode bus bars of the plurality of anode assemblies to form an anode conductor, and attaching the cathode bus bars of the plurality of cathode assemblies to form a cathode conductor; assembling an anode assembly by attaching the anode end cap to the anode conductor of the electrode stack, and attaching the cathode feedthrough assembly to the cathode conductor of the electrode stack; inserting an insulator over the cathode feedthrough conductor; inserting the anode assembly into the vessel side wall of the cathode vessel assembly by inserting the cathode feedthrough conductor through the feedthrough of the cathode end cap; attaching the anode end cap of the anode assembly to the vessel side wall of the cathode vessel assembly; crushing the feedthrough body to seal the insulator of the feedthrough against the cathode feedthrough conductor; adding electrolyte to the electrode stack through the fill tube; and sealing the fill tube.

An electrode stack for a hydrogen metal battery, comprising: an electrode stack, the electrode stack including alternating anode assemblies and cathode assemblies, the anode assemblies and cathode assemblies separated by a separator, each of the anode assemblies including at least one anode layer connected to an anode bus, each of the cathode assemblies including at least one cathode layer connected to a cathode bus, wherein each of the anode buses are electrically and mechanically attached to form an anode conductor, and wherein each of the cathode buses are electrically and mechanically attached to form a cathode conductor.

A method of forming a electrode stack for a metal hydrogen battery, comprising: preassembling components of the metal hydrogen battery by assembling a plurality of cathode assemblies, each cathode assembly having a cathode bus bar attached to one or more cathode material layers, assembling a plurality of anode assemblies, each anode assembly having an anode bus bar coupled to one or more anode material layers, forming separators from separator material, forming frame inner portions and frame outer portions, at least one of the frame inner portion and frame outer portion including fingers that connect the frame inner portion and the frame outer portion; stacking the frame inner portion, the frame outer portion, separators, anode assemblies, and cathode assemblies to capture the electrodes between the frame inner portion and the frame outer portion; pressing the electrodes, the frame inner portion, and the frame outer portion; forming an electrode stack by, while pressure is applied, attaching the frame inner portion to the frame outer portion with the fingers to form a frame, attaching the anode bus bars of the plurality of anode assemblies to form an anode conductor, and attaching the cathode bus bars of the plurality of cathode assemblies to form a cathode conductor.

These and other embodiments are discussed below with respect to the following figures.

### BRIEF DESCRIPTION OF THE FIGURES

An understanding of the features and advantages of the technology described in this disclosure will be obtained by reference to the following detailed description that sets forth illustrative aspects with reference to the following figures.

FIG. 1 illustrates an example of a metal-hydrogen battery according to some aspects of the present disclosure.

FIGS. 2A, 2B, 2C, and 2D illustrate an example of an electrode stack according to some aspects of the present disclosure.

FIGS. 3A, 3B, and 3C illustrate an example of a separator for the electrode stack according to some aspects of the present disclosure.

FIGS. 4A, 4B, 4C, 4D, 4E, and 4F illustrate an example of an anode assembly according to aspects of the present disclosure that can used in the electrode stack illustrated in FIGS. 3A and 3B.

FIGS. 5A, 5B, 5C, 5D, 5E, and 5F illustrate an example of a cathode assembly according to some aspects of the present disclosure that can be used in the electrode stack illustrated in FIGS. 3A and 3B.

FIGS. 6A, 6B, and 6C illustrate an example of assembly of the electrode stack according to some aspects of the present disclosure.

FIGS. 7A, 7B, 7C, 7D, 7E, 7F, 7G, and 7H illustrate an example of a frame as illustrated in FIGS. 6A, 6B, and 6C.

FIGS. 8A, 8B, 8C, 8D, 8E, 8F and 8G illustrate examples of assembly of a battery according to some aspects of the present disclosure.

FIGS. 9A and 9B illustrates an example of a cathode bridge used in a battery as illustrated in FIGS. 8A and 8B.

FIGS. 9C and 9D illustrates an example of a cathode feedthrough conductor as illustrated in FIGS. 8A and 8B.

FIGS. 9E and 9F illustrate an example formation of a cathode feedthrough assembly with the cathode feedthrough conductor of FIGS. 9C and 9D welded to the cathode bridge of FIGS. 9A and 9B.

FIGS. 10A, 10B, and 10C illustrates an example of a cathode end cap as illustrated in FIGS. 8A and 8B.

FIGS. 11A and 11B illustrates an example of a fill tube as illustrated in FIGS. 8A and 8B.

FIGS. 12A, 12B, 12C, and 12D illustrate an example of a feedthrough that can be used with the cathode end cap as illustrated in FIGS. 8A and 8B.

FIGS. 13A, 13B, and 13C illustrate an example of a pressure vessel side wall according to some aspects of the present disclosure.

FIGS. 14A and 14B illustrate an example of assembly of a cathode vessel assembly according to some aspects of the present disclosure.

FIGS. 15A, 15B, and 15C illustrate an example of an anode end cap according to some aspects of the present disclosure.

FIG. 16 illustrates an example formation of coupling an electrode stack with an anode end cap according to some aspects of the present disclosure.

FIGS. 17A and 17B illustrate an example of an isolator according to some aspects of the present disclosure.

FIGS. 18A and 18B illustrates an example of a spacer according to some aspects of the present disclosure.

FIGS. 19A, 19B, 19C, 19D, 19E, 19F, 19G, 19H, 19I, and 19J illustrate an example method of constructing a battery according to some aspects of the present disclosure.

These figures are further discussed below.

### DETAILED DESCRIPTION

In the following description, specific details are set forth describing some aspects of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. Such modifications may include substitution of known equivalents for any aspect of the disclosure in order to achieve the same result in substantially the same way.

Consequently, this description illustrates inventive aspects and embodiments that should not be taken as limiting—the claims define the protected invention. Various changes may be made without departing from the spirit and scope of this description and the claims. In some instances, well-known structures and techniques have not been shown or described in detail in order not to obscure the invention.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Further, individual values provided for particular components are for example only and are not considered to be limiting. Specific dimensional values for various components are there to provide a specific example only and one skilled in the art will recognize that the aspects of this disclosure can be provided with any dimensions. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

In the figures, relative sizes of components are not meaningful unless stated otherwise and should not be considered limiting. Components are sized in the figures to better describe various features and structures without consideration of the displayed sizes with respect to other components. Further, although specific dimensions to describe one example of a battery, those specific dimensions are provided as an example only and are not limiting. Batteries according to aspects of the following disclosure can be formed having any dimensions with components having any relative dimensions.

Metal-hydrogen batteries can be configured in a number of ways. In each case, the battery itself includes an electrode stack with a series of electrodes (alternating cathodes and anodes) separated by electrically insulating separators. The electrode stack is housed in a pressure vessel that contains an electrolyte and hydrogen gas. The electrode stack can provide an array of cells (i.e., pairs of cathode and anode electrodes) that can be electrically coupled in series or in parallel. An electrode stack according to aspects of the present disclosure are arranged such that the cells formed in the array of electrodes are coupled in parallel. The stack can be arranged in an individual pressure vessel (IPV), where each electrode stack is housed in a separate IPV.

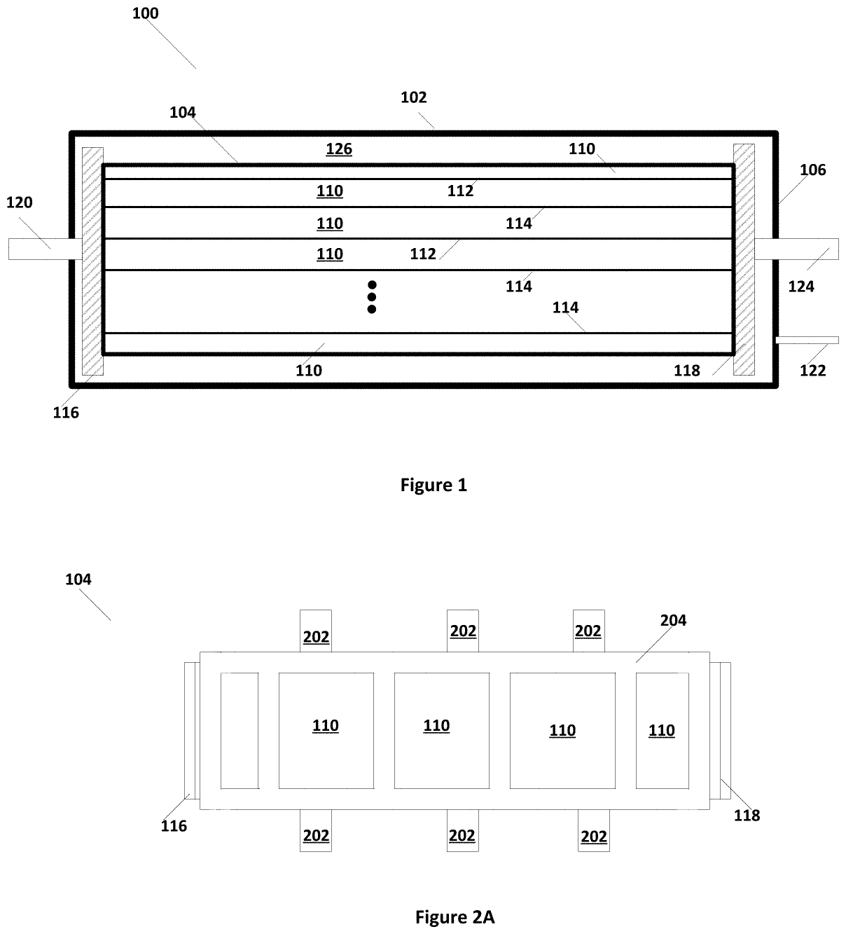

FIG. 1 depicts a schematic depiction of an IPV metal-hydrogen battery 100 according to some aspects of the present disclosure. The metal-hydrogen battery 100 includes electrode stack 104 that includes stacked electrodes separated by separators 110. The electrodes include a cathode 112, an anode 114, and a separator 110 disposed between the cathode 112 and the anode 114. Separator 110 is saturated with an electrolyte 126. In some embodiments, separator 110, in addition to electrically separator cathode 112 and anode 114, also provides a reservoir of electrolyte 126 that buffers the electrodes from either drying out or flooding during operation.

Each pair of cathode 112 and anode 114 can be considered a cell, although there may be additional electrode layers that are not paired. The electrode stack 104 can be housed in a pressure vessel 102. An electrolyte 126 is disposed in pressure vessel 102. The cathode 112, the anode 114, and the separator 110 are porous to keep electrolyte 126 and allow ions in electrolyte 126 to transport between the cathode 112 and the anode 114. In some embodiments, the separator 110 can be omitted as long as the cathode 112 and the anode 114 can be electrically insulated from each other. For example, the space occupied by the separator 110 may be filled with the electrolyte 126. The metal-hydrogen battery 100 can further include a fill tube 122 configured to introduce electrolyte or gasses (e.g. hydrogen) into pressure vessel 102. Fill tube 122 may include one or more valves (not shown) to control flows into and out of enclosure 102, or inlet 122 may be otherwise sealable after charging pressure vessel 102 with electrolyte 126 and hydrogen.

As shown in FIG. 1, electrode stack 104 includes a number of stacked layers of alternating cathode 112 and anode 114 separated by a separate 110. Cells can be formed by pairs of cathode 112 and anode 114 layers. Although the cells in an electrode stack 104 may be coupled either in parallel or in series, in the example of battery 100 illustrated in FIG. 1 the cells are coupled in parallel. In particular, each of cathodes 112 are coupled to a conductor 118 and each of anodes 114 are coupled to conductor 116.

As is illustrated in FIG. 1, conductor 116, which is coupled to anodes 114, is electrically coupled to a terminal 120, which may present the negative terminal of battery 100. Terminal 120 can include a feedthrough to allow terminal 120 to extend outside of pressure vessel 102, or conductor 116 may be connected directly to pressure vessel 102. Similarly, conductor 118, which is coupled to cathode 112, can be coupled to a terminal 124 that represents the positive side of battery 100. Terminal 124 also may include a feedthrough to allow terminal 124 to extend to the outside of pressure vessel 102.

As discussed above, each cell included in electrode stack 104 includes a cathode 112 and an anode 114 that are separated by separators 110. Electrode stack 104 is positioned in pressure vessel 102 where an electrolyte 126 is kept and ions in electrolyte 126 can transport between cathode 112 and anode 114. As is discussed further below, cathode 112 is formed of a porous conductive substrate coated by a porous compound. Similarly, anode 114 is formed of a porous conductive substrate coated by a porous catalyst. Separator 110 is a porous insulator that can separate alternating layers of cathode 112 and anode 114 and to keep electrolyte 126 and let ions in electrolyte 126 to transport between cathode 112 and anode 114. In some embodiments, the electrolyte 126 is an aqueous electrolyte that is alkaline (with a pH greater than 7). Each of anode 114 and cathode 112 can be formed as electrode assemblies with multiply layered structures, as is discussed further below.

Electrode stack 104, the core of battery 100, operates chemically to charge and discharge battery 100 through a hydrogen evolution reaction (HER) and a hydrogen oxidation reaction (HOR). These reactions are more mechanistically complex in alkaline conditions than in acidic conditions. Active alkaline HER/HOR catalysts tend to have more dynamic surfaces. In acidic conditions, the reactions proceed via the reduction of H⁺to H₂ or the oxidation of H₂ to H⁺. The activity of a catalyst for these reactions in acidic conditions can be closely correlated to the binding energy of hydrogen to the metal surface. If hydrogen binds too strongly or too weakly, the catalytic process cannot effectively proceed and the kinetic overpotential will be large. Platinum has an ideal binding energy for hydrogen and demonstrates better HER/HOR performance than any other catalyst in low pH solutions. In alkaline conditions, the concentration of free H⁺is essentially zero, and thus the HER first proceeds via the cleavage of the H—O bond of a water molecule to generate a surface-adsorbed hydrogen atom and a hydroxide anion according to Eq. 1 below. This step is slow on metal surfaces, resulting in alkaline HER exchange current densities that are two to three orders of magnitude smaller than in acid on the same metal. Hydrogen gas is generated according to Eq. 2 or Eq. 3 below. This step (Eq. 1) occurs in reverse as the last step of HOR and is also rate determining as metal surfaces do not interact strongly with the hydroxide anions required to complete the reaction and form H₂O.

H₂O+M+e−↔MH_{ad}+OH− Eq. 1

MH_{ad}+H₂O+e−↔M+H₂+OH⁻ Eq. 2

MHad+MHad↔2M+H₂ Eq. 3

To expedite both HER and HOR on the catalyst, a catalyst material is provided that contains (i) metal sites to bind with hydrogen and (ii) metal oxide/metal hydroxide sites to bind with hydroxide anions. The interfaces where metal and metal oxide meet are highly active for both HER and HOR and an optimal ratio of metal-to-metal oxide is maintained to achieve high catalyst activity. If the catalyst surface becomes too oxidized during prolonged, or high overpotential, HOR, the catalyst surface can become deactivated and the battery performance will suffer as a result.

Accordingly, anode 114 is a catalytic hydrogen electrode. In some embodiments, as discussed above, anode 114 includes a porous conductive substrate with a catalyst layer covering the porous conductive substrate. The catalyst layer of anode 114 can cover the outer surface of the porous conductive substrate of anode 114 and, since the porous conductive substrate has internal pores or interconnected channels, can also cover the surfaces of those pores and channels. The catalyst layer includes a bi-functional catalyst to catalyze both HER and HOR at anode 114. In some embodiments, the porous conductive substrate of anode 114 can have a porosity of at least about 10%, at least about 20%, at least about 30%, at least about 40%, or at least about 50%, and up to about 80%, up to about 90%, up to about 95% or greater. In some embodiments, the porous conductive substrate of anode 114 can be a metal foam, such as a nickel foam, a copper foam, an iron foam, a steel foam, an aluminum foam, or others. In some embodiments, the porous conductive substrate of anode 114 can be a metal alloy foam, such as a nickel-molybdenum foam, a nickel-copper foam, a nickel-cobalt foam, a nickel-tungsten foam, a nickel-silver foam, a nickel-molybdenum-cobalt foam, or others. Other conductive substrates, such as metal foils, metal meshes, and fibrous conductive substrates can be used. In some embodiments, the conductive substrates of anode 114 can be carbon-based materials, such as carbon fibrous paper, carbon cloth, carbon felt, carbon mat, carbon nanotube film, graphite foil, graphite foam, graphite mat, graphene foil, graphene fibers, graphene film, and graphene foam.

In some embodiments, the bi-functional catalyst of the catalyst layer of anode 114 can be a nickel-molybdenum-cobalt (NiMoCo) alloy. Other transition metal or metal alloys as bi-functional catalysts are encompassed by this disclosure, such as nickel, nickel-molybdenum, nickel-tungsten, nickel-tungsten-cobalt, nickel-carbon, nickel-chromium, based composites. In some embodiments, bi-functional catalyst is a transition metal alloy that includes two or more of Ni, Co, Cr, Mo, Fe, Mn and W. Other precious metals and their alloys as bi-functional catalysts are encompassed by this disclosure, such as platinum, palladium, iridium, gold, rhodium, ruthenium, rhenium, osmium, silver, and their alloys with precious and non-precious transition metals such as platinum, palladium, iridium, gold, rhodium, ruthenium, rhenium, osmium, silver, nickel, cobalt, manganese, iron, molybdenum, tungsten, chromium and so forth. In some embodiments, bi-functional catalysts are a combination of HER and HOR catalysts. In some aspects, the bi-functional catalysts of the metal-hydrogen battery 100 include a mixture of different materials, such as transition metals and their oxides/hydroxides, which contribute to hydrogen evolution and oxidation reactions as a whole. In some embodiments, the catalyst layer of anode 114 includes nanostructures of the bi-functional catalyst having sizes (or an average size) in a range of, for example, about 1 nm to about 100 nm, about 1 nm to about 80 nm, or about 1 nm to about 50 nm. In some embodiments, the catalyst layer 104 includes microstructures of the bi-functional catalyst having sizes (or an average size) in a range of, for example, about 100 nm to about 500 nm, about 500 nm to about 1000 nm.

In some embodiments, to create different affinities with respect to the electrolyte (e.g., electrolyte 126) on the anode 114, the catalyst layer may be partially coated with a surface-affinity modification material. For example, when the catalyst layer of anode 114 on the porous substrate of anode 114 are hydrophilic to the electrolyte, the catalyst layer of anode 114 may be partially or entirely coated with a material that is hydrophobic to the electrolyte. On the contrary, when the catalyst layer of anode 114 on the porous substrate of anode 114 are hydrophobic to the electrolyte, the catalyst layer of anode 114 may be partially or entirely coated with a material that is hydrophilic to the electrolyte. This structure can facilitate movement of hydrogen gas in the pores of the anode 114 and improve HOR during discharge.

The cathode 112 may include a conductive substrate and a coating covering the conductive substrate. The coating can include a redox-reactive material that includes a transition metal. In some embodiments, the conductive substrate of cathode 112 is porous, such as having a porosity of at least about 10%, at least about 20%, at least about 30%, at least about 40%, or at least about 50%, and up to about 80%, up to about 90%, or greater. In some embodiments, the conductive substrate of cathode 112 can be a metal foam, such as a nickel foam, or a metal alloy foam. Other conductive substrates are encompassed by this disclosure, such as metal foils, metal meshes, and fibrous conductive substrates. In some embodiments, the transition metal included in the redox-reactive material is nickel. In some embodiments, nickel is included as nickel hydroxide or nickel oxyhydroxide. In some embodiments, the transition metal included in the redox-reactive material is cobalt. In some embodiments, cobalt is included as cobalt oxide or zinc cobalt oxide. In some embodiments, the transition metal included in the redox-reactive material is manganese. In some embodiments, manganese is included as manganese oxide or doped manganese oxide (e.g., doped with nickel, copper, bismuth, yttrium, cobalt or other transition or post-transition metals). Other transition metals are encompassed by this disclosure, such as silver. In some embodiments, the cathode 112 is a cathode, and the anode 114 is an anode. In some embodiments, the coating microstructures of the redox-reactive material, may have sizes (or an average size) in a range of, for example, about 1 μm to about 100 μm, about 1 μm to about 50 μm, or about 1 μm to about 10 μm.

In some embodiments, the electrolyte 126 is an aqueous electrolyte. The aqueous electrolyte is alkaline and has a pH greater than 7, such as about 7.5 or greater, about 8 or greater, about 8.5 or greater, or about 9 or greater, or about 11 or greater, or about 13 or greater. As a non-limiting example, the electrolyte 126 may include KOH or NaOH or LiOH or a mixture of LiOH, NaOH and/or KOH.

Although hydrogen oxidation catalysts such as inexpensive transition metals are suitable for metal-hydrogen batteries, they may be passivated during prolonged HOR, and this may significantly hindered their use in practical devices. According to some embodiments of the present disclosure, catalyst of anode 114 can be a bi-functional TMA (transition metal alloy). In some embodiments, combinations of Ni, Co, Cr, Mo, Fe and W can be used as an alternative to the bi-functional TMA catalyst. For example, a catalyst composed of Ni with CrOx particles decorating the surface can be used. A small amount of Pt can be added to further improve the activity. One such TMA catalyst is described in U.S. patent application Ser. No. 16/373,247, which is herein incorporated by reference in its entirety.

Furthermore, each of cathode 112 and anode 114 may include multiple layers of materials as described above. One example of a multi-layer structure anode 114 is provided in U.S. Provisional Application 63/214,514, which is herein incorporated by reference in its entirety.

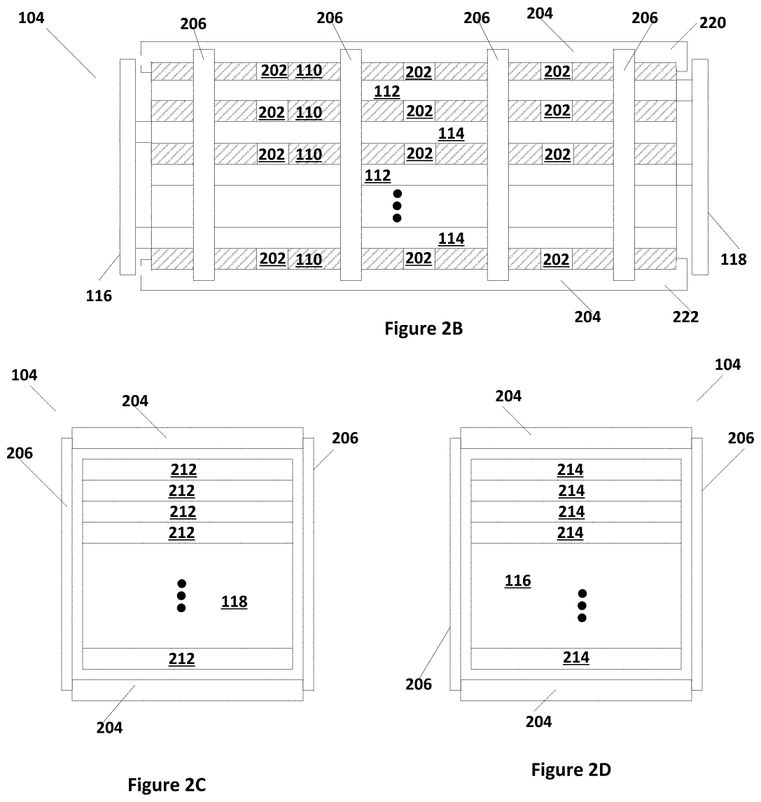

FIGS. 2A, 2B, 2C, and 2D further illustrate electrode stack 104 according to some embodiments. In accordance with some aspects of this disclosure, each of cathode 112, anode 114, and separator 110 are substantially planar of approximately the same planar surface area. Each of cathode 112, anode 114, and separator 110 can be produced, as is further discussed below, in material sheets of the appropriate material as discussed above and cut appropriately to form electrode stack 104 as discussed here and further below. FIGS. 2A and 2B illustrate a top and a side view of electrode stack 104, respectively. In this reference, “top” refers to a view towards a planar side of cathode 112, anode 114, and separator 110 and “side” refers to a view into (i.e. along) the planar sides of cathode 112, anode 114, and separator 110, perpendicular to the top view. FIG. 2C is a cathode end view, where each of cathodes 112 are connected, and FIG. 2D is an anode end view, where each of anodes 114 are connected.

As is illustrated in the top view illustrated in FIG. 2A, electrode stack 104 can be contained in a frame 204. Frame 204 can be metallic structure that allows the incursion of electrolyte 126 into the layered electrode stack 104. As is illustrated, and visible through this embodiment of frame 204, separator 110 may be the top layer to electrically isolate whichever is the first electrode under the top separator 110 in the stack. In some embodiments, anode 114 can form the top and bottom layers of electrode stack 104, in which case the top/bottom separator 110 (i.e. between electrode stack 104 and frame 204) is omitted. In some embodiments, frame 204 may include a solid plate over separator 110 in the stack, without large openings as illustrated in FIG. 2A. As is further illustrated in FIG. 2A, in accordance with some aspects of this disclosure, each of separators 110 illustrated in FIG. 1 can include one or more wick tabs 202. Wick tabs 202 can extend to contact the inner side surface of pressure vessel 102 when electrode stack 104 is placed in pressure vessel 102. The length of wick tabs 202 can be sufficient to allow electrolyte 126 to be wicked from the inner side surface of pressure vessel 102 into electrode stack 104, which allows circulation of electrolyte 126. It should be noted that a “bottom” view of electrode stack 104 appears identical to the top view shown in FIG. 2A.

FIG. 2B illustrates a side view of electrode stack 104 according to some aspects of this disclosure. FIG. 2B illustrates layers of anodes 114 and cathodes 112 separated by separators 110. As is illustrated, each of separators 110 includes at least one wick tab 202. Although, in this example, three wick tabs 202 are illustrated for each of separators 110, and for each side of stack 104, any number of wick tabs 202 can be included.

As is further illustrated in FIG. 2B, frame 204 includes a top portion 220 and a bottom portion 222 that are connected by side supports 206. As illustrated in FIG. 2A, top portion 220 and bottom portion 222 cover separator 202 on the top and bottom, respectively, of electrode stack 104. As is further illustrated, each of cathodes 112 is electrically connected to conductor 118 while each of anodes 114 are electrically connected to conductor 116.

As is further illustrated in FIG. 2B, top portion 220 and bottom portion 222 are structurally connected with side supports 206. There may be any number of side supports 206 on each side. Side supports 206 can, for example, be welded to fix top portion 220 and bottom portion 222 and therefore fix the stacked electrodes of electrode stack 104 within the fixed frame 204. As discussed in further detail below, the stack of electrodes can be formed between bottom portion 222 and top portion 220, pressure applied to the stack, and side supports 206 welded to top portion 220 and bottom portion 222 while pressure is applied to form frame 204. As is discussed further below, in some embodiments, top portion 220 and bottom portion 222 may be formed separately and side supports used to fix top portion 220 relative to bottom portion 222.

FIG. 2C illustrates an end view looking onto conductor 118 according to some embodiments. As illustrated in FIG. 2C, end conductor 118 can be formed by stacking cathode bus bars 212, each of which is electrically coupled to a cathode 112. Cathode bus bars 212 can be electrically and mechanically attached (e.g. by welding) to form conductor 118.

Similarly, FIG. 2D illustrates stacked anode bus bars 214 to form conductor 116. Anode bus bars 214 are electrically connected with anodes 114 and are electrically and mechanically attached, e.g. by welding, to form anode conductor 116.

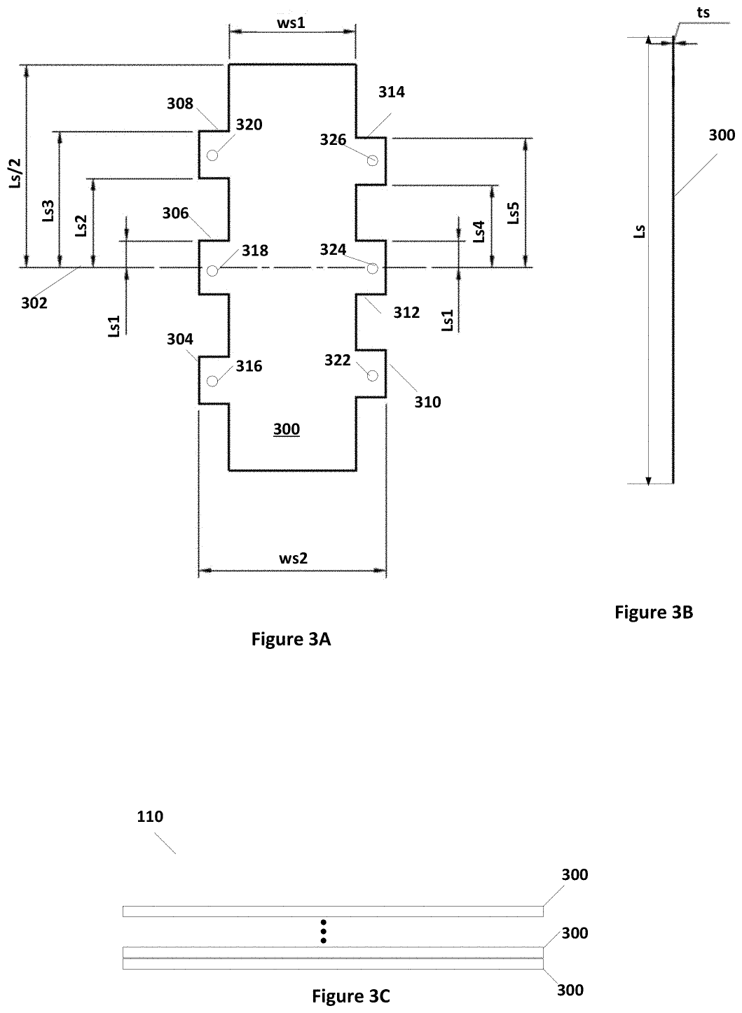

FIGS. 3A, 3B, and 3C illustrate formation of a separator 110 according to some embodiments. FIGS. 3A and 3B illustrates a separator layer 300, which as illustrated in FIG. 3C can be stacked to form separator 110. As discussed above, separator layer 300 can be formed from sheets of separator materials, for example a porous plastic, of thickness is as illustrated in FIG. 3B. FIG. 3A illustrates a planar view onto the surface of separator layer 300. As illustrated in FIG. 3A, wick tabs 202 as illustrated in FIG. 2A are illustrated by wick tabs 304, 306, 308, 310, 312, and 314 in FIG. 3A. Wick tabs 304, 306, 308, 310, 312, and 314 are positioned symmetrically around a center line 302, and may also be symmetrical (as shown in FIG. 3A) on each side. However, in some embodiments, wick tabs 304, 306, 308, 310, 312, and 314 may have different sizes and placement on opposite sides of separator 110. Wick tabs 304, 306, 308, 310, 312, and 314 offer a width wₛ2 of separator layer 300 while the main body of separator layer 300 has width wₛ1, providing a length of each of wick tabs 304, 306, 308, 310, 312, and 314 of (wₛ2-wₛ1). The overall length of separator 110 is Lₛ. Further, from center line 302, wick tab 318 extends from −Lₛ1 to +Lₛ1, wick tab 308 extends from Lₛ2 to Lₛ3, wick tab 316 extends from −Lₛ2 to −Lₛ3, wick tab 312 extends from −Lₛ1 to Lₛ1, wick tab 314 extends from Lₛ4 to Lₛ5, and wick tab 310 extends from −Lₛ4 to −Lₛ5. As shown in FIG. 3B, separator layer 300 has thickness tₛ. A particular example of separator layer 300 can be provided with the following dimensions: Lₛ=241 mm; Lₛ1=16.0 mm; Lₛ2=53.0 mm; Lₛ3=81.0 mm; Lₛ4=49.0 mm; Lₛ5=77.0 mm; wₛ1=75.0 mm; wₛ2=111.0 mm; and tₛ=0.25 mm. However, separator layer 300 may have any set of dimensions, in particular separator layer 300 can be symmetric on each side. Further, in some embodiments, separator layer 300 can be formed of a sufficiently porous plastic.

Further, in some embodiments as illustrated in FIG. 3A, each of wick tabs 304, 306, 308, 310, 312, and 314 includes an alignment hole 316, 318, 320, 322, 324, and 326, respectively. Alignment holes 316, 318, 320, 322, 324, and 326 can, as is discussed further below, be used during assembly of electrode stack 104. Alignment holes 316, 318, 320, 322, 324, and 326 can be positioned anywhere on wick tabs 304, 306, 308, 310, 312, and 314, respectively.

FIG. 3C illustrates formation of separator 110 from one or more separator layers 300. As illustrated, separator 110 may include any number of stacked separator layers 300. In some embodiments, for example, two (2) separator layers 300 are used to form separator 110.

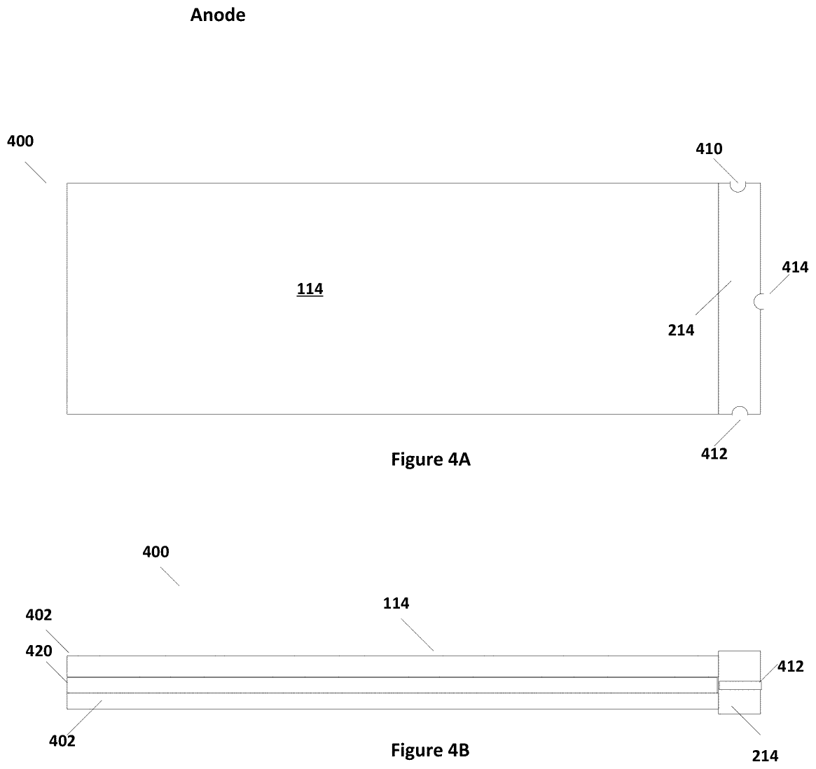

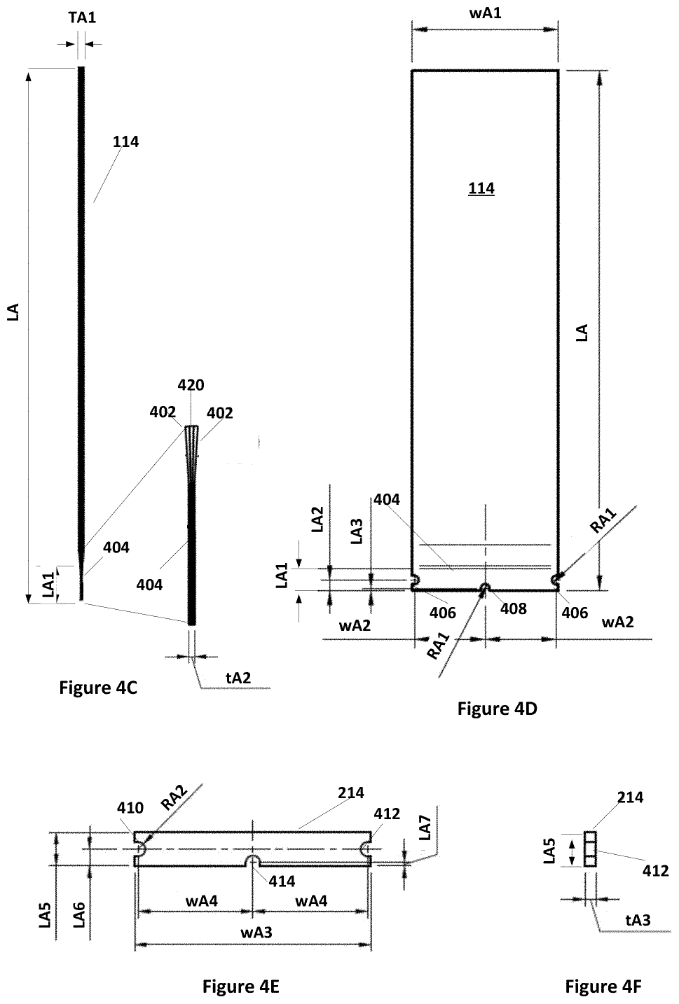

FIGS. 4A through 4F illustrate an anode assembly 400 that, as illustrated in FIG. 4A, includes anode 114 and bus-bar 214. FIGS. 4A and 4B illustrate an example of anode assembly 400, FIGS. 4C and 4D illustrate an example of anode 114, and FIGS. 4E and 4F illustrate an example of bus bar 214. Anode assembly 400 according to some aspects of the disclosure includes anode 114 electrically and mechanically coupled with anode bus bar 214 as is illustrated in the top view illustrated in FIG. 4A. FIG. 4A also illustrates that anode bus bar 214 can include alignments 410, 412, and 414 that, among other functions, can be used to align anode assembly 400 within stack 104. As illustrated in the side-view illustrated in FIG. 4B, anode 114 can include multiple layers of anode material. As illustrated in FIG. 4B, in some embodiments anode 114 can include three layers. In some embodiments, a layer 420 can separate two layers 402. As discussed above, in some embodiments layers 402 and 420 can be formed with anode material (e.g., a nickel foam substrate) with layer 420 being corrugated while layers 402 are not. This arrangement of anode layers aids in hydrogen gas transport into and out of the center of stack 104. Other arrangements of anode 114 can be formed. Bus bar 214 is attached to anode 114 to aid in stacking and form an anode conductor 116 when stack 104 is assembled.

FIGS. 4C and 4D illustrate anode 114 according to some aspects of the present disclosure. In this example, anode 114 includes three layers, two layers 402 and a layer 420, as discussed above with respect to FIG. 4B. As illustrated in FIGS. 4C and 4D, anode 114 can be formed using one or more sheets of anode material as discussed above. Each of layers 402 and 420 can be cut from sheets of anode material. Anode 114 can be characterized as being of overall length L_{A} and width w_{A}1. The thickness TA1 of anode 114 is the thickness of the three material layers, two anode material layers 402 and center layer 420. A tab portion 404 of length LA1 is formed on one end of anode 114. Tab portion 404 is formed by pressing the three anode material layers together to bind the three layers and flatten that section. FIG. 4C illustrates layers 402 and 420 being pressed to form tab portion 404. Tab portion 404 can have a thickness T_{A}2 over a length L_{A}1 from one end of layer 402. Anode bus bar 214 can be spot welded on the tab section 404. As is further illustrated in FIG. 4D, in some aspects alignment notches 406 and 408 are formed within the length L_{A}1 of tab portion 404. Alignment notches 406 are positioned at L_{A}2 from the end while alignment notch 408 is positioned at the center, length wA2 from each side. Alignment portions 406 and 408 are formed by circles of radius RA1. The center of alignment portion 408 is separated from the center of alignment holes 406 by a length LA3.

FIGS. 4E and 4F illustrate a bus bar 214 that is electrically and mechanically connected to the anode 114 as illustrated in FIGS. 4A and 4B. As indicated above, bus bar 214 is spot welded onto tap section 404 of anode 114. FIG. 4E illustrates a top view of bus bar 214 and FIG. 4F illustrates a side view of bus bar 214. Anode bus bar 214 can be formed from any metal conductor, for example nickel, and has width W_{A}2, length L_{A}5, and thickness t_{A}3. As is further illustrated in FIG. 4E, bus 214 includes alignments 410, 412, and 414, each of which are formed with holes of radius R_{A}. Alignments 410 and 412 are located at length L_{A}6 from the side that includes alignment 414. Alignment 414 is centered at length L_{A}7 from the side that includes alignment 414. When bus bar 214 is attached to tap section 404 of anode 114, alignments 410 and 412 can be aligned with alignment notches 406 and 408 of tab portion 404.

The relative dimensions illustrated in FIGS. 4A, 4B, 4C, and 4D can vary according to a specific system. A specific example that is consistent with the specific example of separator 110 described above with respect to FIGS. 3A and 3B can be as follows: L_{A}=250 mm; L_{A}1=10.2 mm; L_{A}2=5 mm; L_{A}3=1 mm; L_{A}5=10.000 mm; L_{A}6=5.000 mm; L_{A}7=1.000 mm; w_{A}1=70 mm; w_{A}2=34.000 mm; w_{A}3=70.000 mm; w_{A}4=34.000 mm; t_{A}2=0.45 mm; t_{A}3=3.175 mm; R_{A}1=2.1000 mm; and R_{A}2=3.100 mm. In some embodiments, anode assembly 400 can be coated, for example with a Teflon coating. After which, anode assembly 400 may be oven dried and sintered to finalize production of anode assembly 400.

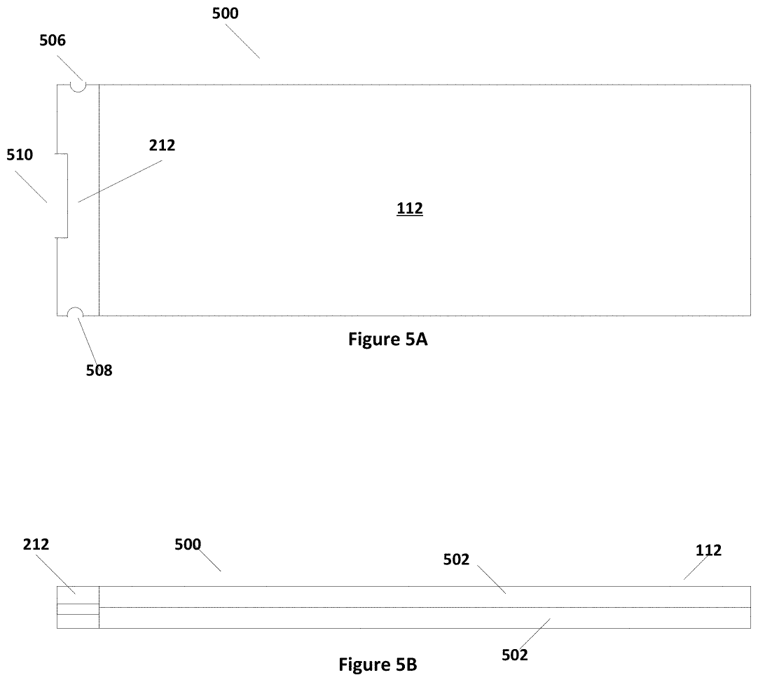

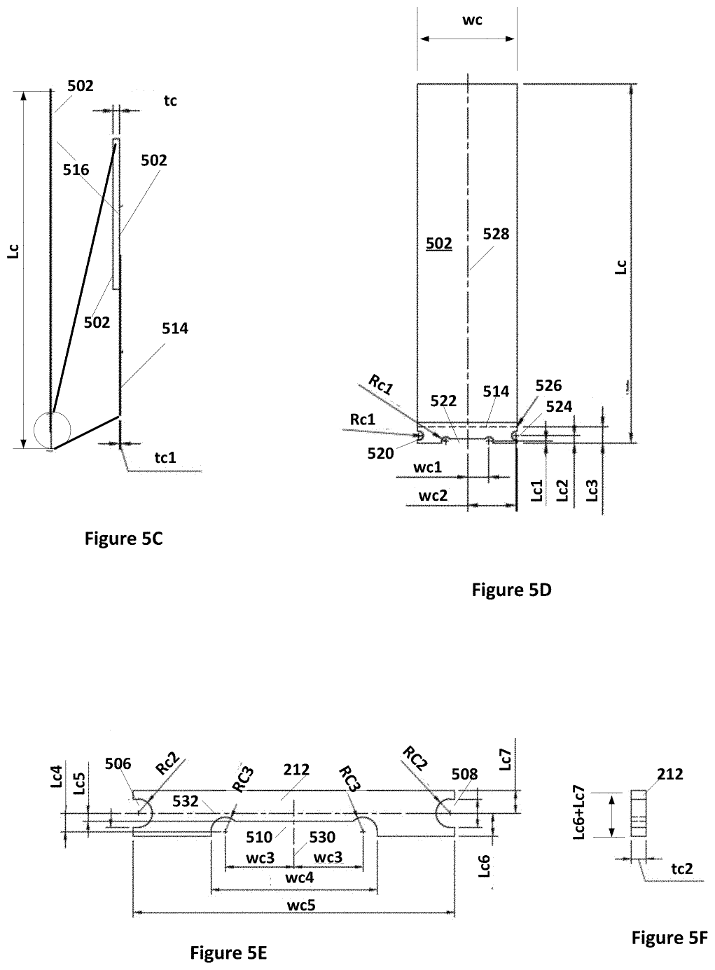

FIGS. 5A through 5I illustrate formation of a cathode assembly 500 according to some aspects of the present disclosure. As illustrated in FIG. 5A, cathode assembly 500 includes cathode 112 attached to a cathode bus bar 212. As illustrated in FIG. 5B, and discussed above, cathode 112 may include multiple layers 502 of cathode material. Bus bar 212, as illustrated in FIG. 5A, can include an alignment notch 510 and alignments 506 and 508. Alignment notch 510, as is discussed further, can assist electrically connecting the cathode conductor 118 formed by stacking layers of cathode assemblies 500. Alignments 510, 506, and 508 can be used during formation of electrode stack 104. It should be recognized that alignments 506, 508, and 510 can be any shape and the particular shapes discussed here are examples and are not to be considered to be limiting.

FIGS. 5C and 5D illustrate an example of layer 502 of an example cathode 112 as illustrated in FIGS. 5A and 5B. Layer 502 can be formed from a larger sheet of cathode material sheet and a tab 514 that is attached to the cathode material 516. The example layer 502 illustrated in FIGS. 5C and 5D has a length L_{c} and width w_{c}. The cathode material 516 of layer 502 can have a thickness t_{c}. As is illustrated in FIG. 5C, layer 502 includes tab 514 attached to one end of the cathode material layer 516. In some embodiments, the cathode material sheet can be purchase with tab 514 already attached and cathode layer 502 formed by cutting the cathode material sheet. Tab 514 can be made of any metal, for example nickel plated SPCC steel (a grade of cold rolled steel) and can be resistance seam welded onto the cathode material. As discussed further below, cathode bus bar 214 can be welded to tab 514 of two cathode layers 502 to complete the cathode assembly 500 illustrated in FIGS. 5A and 5B. As illustrated in FIG. 5D, tab 514 can be cut to form an alignment notch 522 and two alignments 520 and 524. As illustrated, alignments 520 can be formed with a hole of radius Rc1 centered at a width wc2 from a center line 528 and a length Lc2 from the end of tab 514 of cathode layer 502. Alignment notch 522 can be formed by two holes of radius Rc1 formed at a width wc1 from center line 528 and depth Lc1 from the end. A weld point at length Lc3 from the end illustrates where tab 514 is welded to cathode material layers 502.

FIGS. 5E and 5F illustrate an example of cathode bus bar 212. As discussed above, cathode bus bar 212 is electrically and mechanically connected to cathode material 516 at cathode tab 514, which is illustrated in FIGS. 5A and 5B. Cathode bus bar 212 can be formed from any metal conductor, for example nickel, and has width w_{c}1, length Lc6+Lc7, and thickness t_{c}2. In the example illustrated in FIG. 5E, cathode bus bar 212 includes alignments 506, 508, and 510. Alignments 506 and 508 are formed by holes on opposite edges of cathode bus 212 with radius R_{c}2, positioned at a length L_{c}5 from the edge and separated from a center line 530 of the width by a width w_{c}2 to match alignments 520 and 524 of cathode 112. Alignment 510 is a slot of center width w_{c}4 centered on the width of cathode bus 212. Alignment 510 further can have any shaped edges (e.g. tapered edges, straight edges, or other edges) that results in the overall width of the slot to be w_{c}4. In the example illustrated in FIG. 5E, alignment slot 510 includes two holes on each side of radius Rc3, separated from the center line 530 by a width of wc3 on each side, and centered at a length Lc4 from center line 532 along of bus bar 214. The depth of the slot of alignment 510 is given by length L_{c}5. Alignments 506, 508, and 510 align with alignments 520, 524, and 522 of cathode layer 502. The alignments 506, 508, and 510 of cathode bus bar 212 differ from alignments 410, 412, and 414 of anode bus 214, which helps to distinguish the two during assembly of electrode stack 104 so that there are no errors in positioning anode assembly 400 relative to cathode assembly 500. Further, alignment notch 510 allows for connection of a cathode assembly to the cathode conductor 118 formed by stacked cathode bus bars 212, as is discussed further below.

Once the cathode layer 502 is cut to shape with tab 514 attached to cathode material 516, bus bar 212 is spot welded onto tab 514 of two cathode layers 502 forming a single 2-layer cathode assembly 500. The nickel bus bar 212 aids in stacking and forms a cathode bus 218 that is discussed further below.

Although the dimensions of cathode assembly 500 can be any dimensions, a specific example of the dimensions illustrated in FIGS. 5C through 5F that are consistent with the specific examples illustrated in FIGS. 3A and 3B and 4A through 4D can be as follows: Lc=251.0 mm; Lc1=1.0 mm; Lc2=5.0 mm; Lc3=11.0 mm; Lc4=4.0 mm; Lc5=1.8 mm; Lc6=5.0 mm; Lc7=5.0 mm; wc=70.0 mm; wc1=15.0 mm; wc2=34.0 mm; wc3=15.0 mm; wc4=36.2 mm; wc5=70.0 mm; tc=0.5 mm; tc1=0.1 mm; tc2=3.2 mm; Rc1=3.1 mm; Rc2=3.1 mm; and Rc3=3.1 mm. It should be noted that dimensions for a specific compatible example of separator 110, anode assembly 400, and cathode assembly 500 are provided for illustration only. This specific example is not to be considered limiting and instead is one specific example of aspects of the present disclosure. One skilled in the art can provide any set of compatible dimensions for constructions of an electrode stack 104 according to this disclosure.

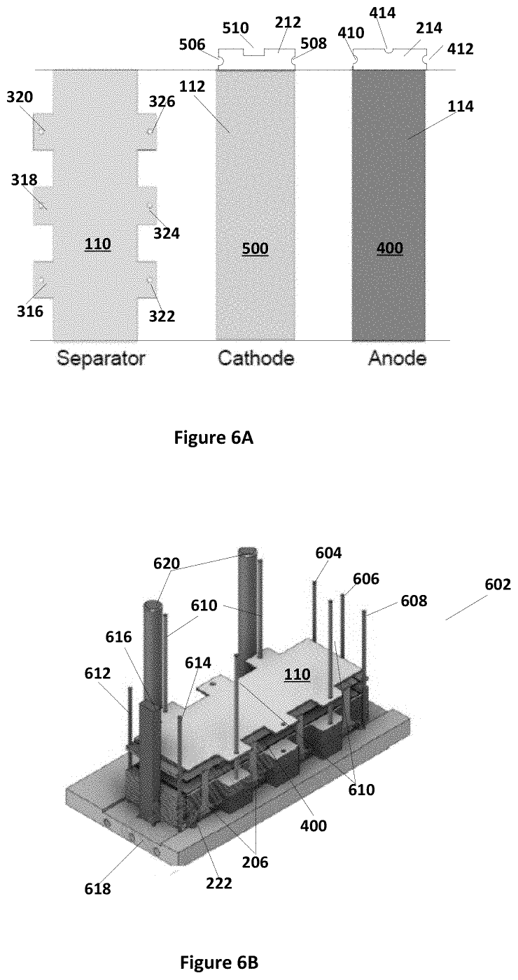

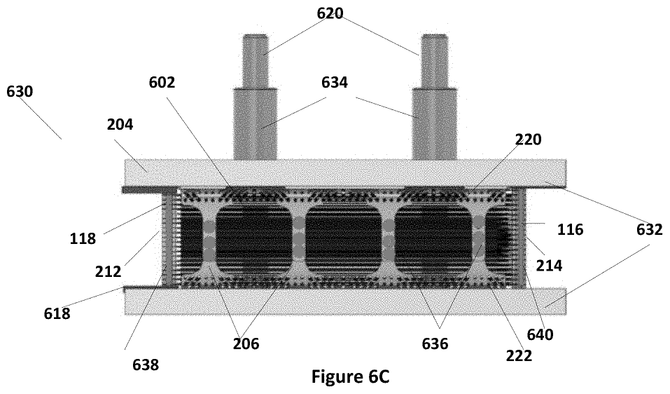

FIG. 6A further illustrates separator 110, cathode assembly 500, and anode assembly 400, as described above, relative to one another. FIG. 6B illustrates an assembly of electrode stack 104 by configuring and stacking the electrodes and separators using an alignment jig 602. As is illustrated in FIG. 6B, alignment jig 602 is arranged on a base 618 and includes multiple alignment rods that correspond to the alignments discussed above with respect to separator 110, anode assembly 400, and cathode assembly 500. In particular, alignment rods 604, 606, and 608 align with alignments 410, 414, and 412, respectively, of anode assembly 400. Alignment rods 612, 614, and 616 align with alignments 506, 508, and 510 of cathode assembly 500. Further, alignment rods 610 are each positioned to align with one of alignment holes 316, 318, 320, 322, 324, and 326 of separator 110. As is illustrated, when the alignment rods are positioned with the corresponding alignments of the corresponding one of separator 110, cathode assembly 500, or anode assembly 400, then that component is properly aligned on alignment jig 602.

In operation, an operator with an appropriate number of separators 110, cathode assembly 500, and anode assembly 400 can quickly and accurately assemble an electrode stack 104. Starting with placing bottom portion 222 of frame 204, to which side supports 206 may already be attached, into jig 602. Then the operator adds electrode assemblies separated by separators 110, alternating between anode assemblies 400 and cathode assemblies 500 separated by separators 110, until the stack is full width the appropriate number of anode assemblies 400 and cathode assemblies 500. In some embodiments, two separators 110 may be stacked to better insulate between other stacked electrodes. In a particular example, electrode stack may include twenty (21) anode assemblies 400 (each with three anode layers) and twenty (20) cathode assemblies 500 (each with two cathode layers). Providing anode assemblies 400 on both sides of the electrode stack prevents cathode assemblies 500 from shorting against frame 204 and the symmetry to help in the repeated charge/discharge cycles. Finally, top portion 220 is added to the stack in jig 602.

Once the layers of separator 110, anode assembly 400, and cathode assembly 500 are assembled on alignment jig 602, then as shown in FIG. 6C alignment jig 602 is placed in a press 630. Press 630 is aligned with alignment rods 620 on base 618 of jig 602, which insert into sleeves 634 of press 630. Press 630 includes jaws 632 that press the stack of electrodes and separators in jig 602. Although any pressure can be used, in a specific example consistent with the dimensions provided above, 0.58 MPa of pressure can be applied. While under pressure, side supports 206 can be welded in spots 636. Additionally, anode buses 214 for each of anode assemblies 400 are welded together at weld 640 to form conductor 116 and cathode buses 212 for each of cathode assemblies 500 are welded together at weld 638 to form conductor 118. After the welding process, the assembled electrode stack 104 can be removed from press 630 and alignment jig 602.

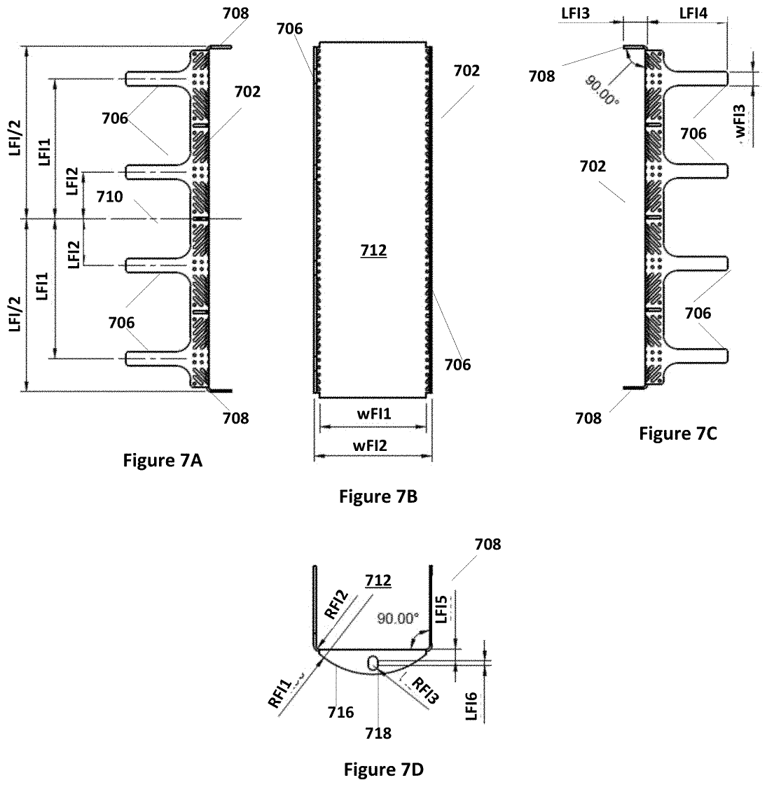

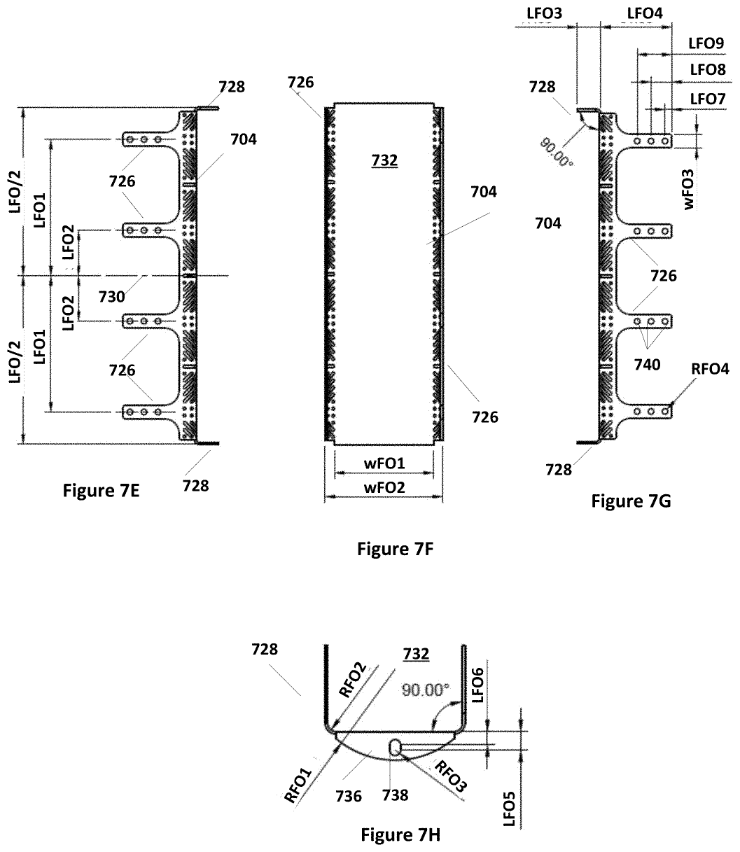

FIGS. 7A through 7H illustrate an example of top portion 220 and bottom portion 222 of frame 204, which are overlapped and welded as indicated in FIG. 6C to form side supports 206, forming frame 204. FIGS. 7A through 7D illustrate an inner section 702, which may be top portion 220 or bottom portion 222. FIGS. 7E through 7H illustrate an outer section 704, which also may be top portion 220 or bottom portion 222 of frame 204. Inner section 702 and outer section 704 are aligned and attached to form frame 204.

Inner portion 702 is illustrated in FIGS. 7A through 7D. FIG. 7A illustrates a first side view of inner portion 702, FIG. 7B illustrates a planar view of inner portion 702, and FIG. 7C illustrates another side view of inner portion 702. As illustrated in FIG. 7A, inner portion 702 illustrates fingers 706 that are spaced along a length of inner portion 702. A tab section 708 extends from each elongated end of inner portion 702. Tab section 708 is illustrated in FIG. 7D.

FIG. 7A illustrates a side view of inner portion 702. As illustrated in FIGS. 7A and 7B, inner portion 702 has a length of LFI and an overall width of wFI2. As is illustrated in FIGS. 7A and 7C, fingers 706 are arranged along the long edge of inner portion 702. In the example illustrated in FIGS. 7A and 7B, four fingers 706 are distributed around a center line 710 on each side such that the two inside fingers 706 are each at length LFI2 from center line 710 (separated by 2*LFI2) while the other two fingers 706 are each at length LFI1 from center line 710 (separated by 2*LFI1). As shown in FIG. 7B, although the overall width of inner portion 702 is wFI2, the width of a plate 712 where fingers 706 are integrally formed is wFI1. As is illustrated in FIG. 7C, each of fingers 706 extends to a length of LFI4 from plate 712 and has a width of wFI3.

As is illustrated in FIGS. 7A and 7D, tab 708 extends a length LFI3 perpendicularly from plate 712. As illustrated in FIG. 7D, tab 708 can be a rounded end portion 716 with a mounting hole 718 in the rounded end portion 716 extending at a right angle from plate 712. In the example illustrated in FIG. 7D, portion 716 is formed with a rounded portion with radius RFI1 that transitions from flat portion 714 with a radius of RFI2. Hole 718 can be elongated and formed by two holes of radius RFI3 spaced a length LFI4 from a center, which is spaced a length LFI3 from an end of flat portion 714.

Outer portion 704 is illustrated in FIGS. 7E through 7H. FIG. 7E illustrates a first side view of outer portion 704, FIG. 7F illustrates a planar view of outer portion 704, and FIG. 7G illustrates another side view of outer portion 704. As illustrated in FIG. 7E, outer portion 704 illustrates fingers 726 that are spaced along a length of outer portion 704. A tab section 728 extends from each elongated end of outer portion 704. Tab section 728 is illustrated in FIG. 7H.

FIG. 7E illustrates a side view of outer portion 704. As illustrated in FIGS. 7E and 7G, outer portion 704 has a length of LFO and an overall width of wFO2. As is illustrated in FIGS. 7E and 7G, fingers 726 are arranged along the long edge of outer portion 704. In the example illustrated in FIGS. 7E and 7G, four fingers 726 are distributed around a center line 730 on each side such that the two inside fingers 726 are each at length LFO2 from center line 730 (separated by 2*LFO2) while the other two fingers 726 are each at length LFO1 from center line 730 (separated by 2*LFO1). As shown in FIG. 7F, although the overall width of inner portion 704 is wFO2, the width of a plate 732 where fingers 726 are attached is wFO1. As is illustrated in FIG. 7G, each of fingers 726 extends to a length of LFO4 from plate 732 and has a width of wFO3.

As is further illustrated in FIG. 7E and 7G, each of fingers 726 includes holes 740. In the particular example illustrated here, holes 740 can include three holes positioned at LFO7, LFO8, and LFO9 from the end of fingers 726. As frame 204 is formed, fingers 726 of outer portion 704 can engage be welded with fingers 706 of inner portion 702 through holes 740.

As is illustrated in FIGS. 7E and 7H, tab 728 extends a length LFO3 perpendicularly from plate 732. As illustrated in FIG. 7H, tab 728 includes portion 716 with a mounting hole 718 extending perpendicularly from plate 732. In the example illustrated in FIG. 7H, the rounded portion 736 is formed with a rounded portion with radius RFO1 that transitions from plate 732 with a radius of RFO2. Hole 7#8 can be elongated and formed by two holes of radius RFO3 spaced a length LFO4 from a center, which is spaced a length LFO3 from an end of plate 732.

In a particular specific example of inner portion 702 and outer portion 704, the dimensions can be given by: LFI=241.2 mm; LFI1=97.5 mm; LFI2=32.5 mm; LFI3=17.0 mm; LFI4=56.0 mm; LFI5=8.0 mm; LFI6=3.0 mm; wFI1=72.0 mm; wFI2=80.0 mm; wFI3=10.0 mm; RFI1=54.0 mm; RFI2=2.5 mm; RFI3=3.25 mm; LFO=241.2 mm; LFO1=97.5 mm; LFO2=32.5 mm; LFO3=17.0 mm; LFO4=51.0 mm; LFO5=11.0 mm; LFO6=8.0 mm; LFO7=5.0 mm; LFO8=15.0 mm; LFO9=25.0 mm wFO1=70.0 mm; wFO2=83.0 mm; wFO3=10.0 mm; RFO1=54.0 mm; RFO2=5.0 mm; and RFO3=3.3 mm. In particular, inner portion 702 and outer portion 704 can be formed from sheets of stainless steel that is cut and bent as described above. In some embodiments, fingers 706 and 726 can be formed separately and welded to plates 712 and 732, respectively, to form inner portion 702 and outer portion 704 as described above. Outer portion 704 mates, and is welded to, inner portion 702 to form frame 204.

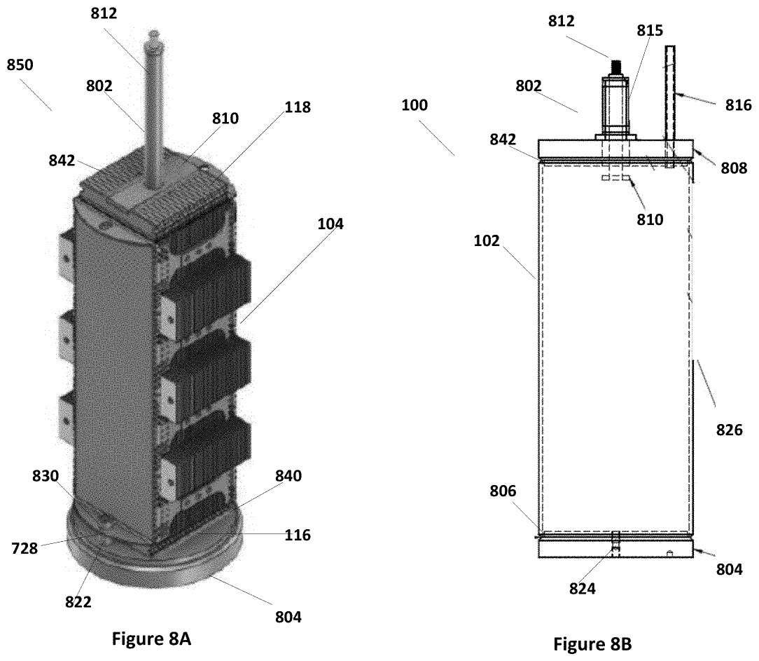

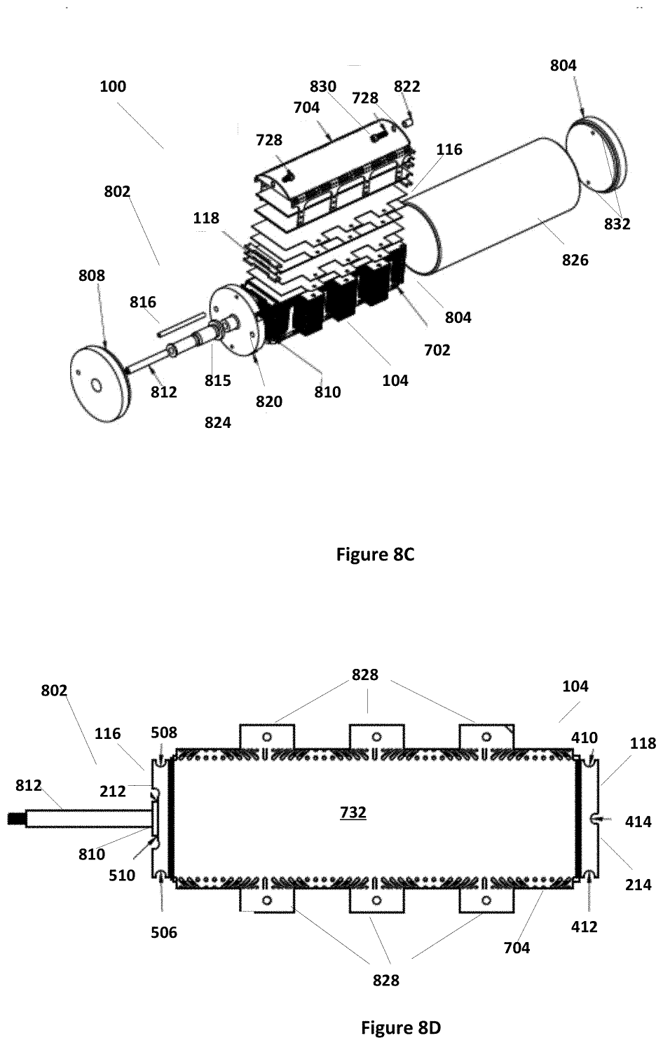

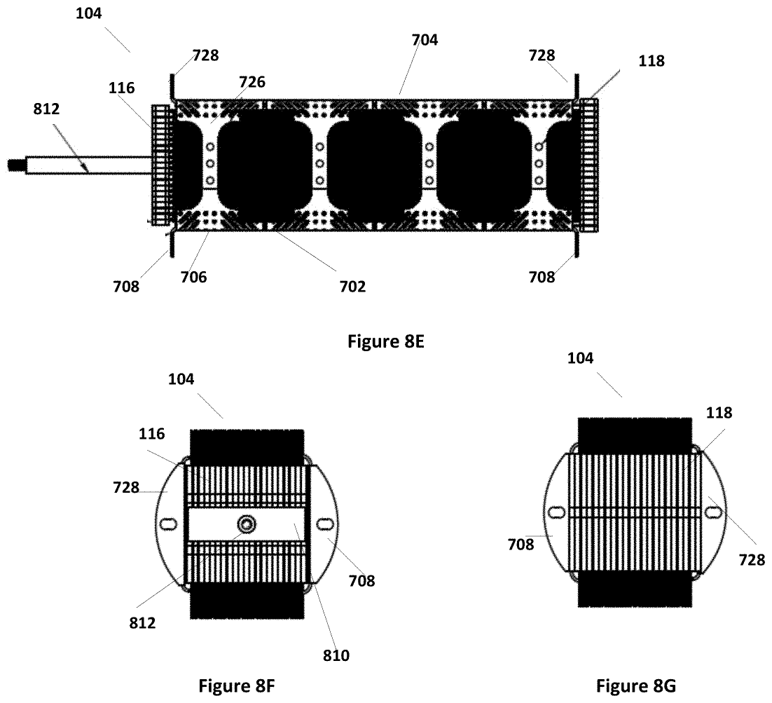

FIGS. 8A through 8G illustrates aspects of the assembly of battery 100 with the components as described above. FIG. 8A illustrates an anode assembly 850 that includes electrode stack 104 with an attached cathode feedthrough assembly 802 attached to cathode conductor 118 and anode end cap 804 attached to anode conductor 116 of stack 104. As is illustrated in FIG. 8A, feedthrough assembly 802 includes a bridge 810 and cathode feedthrough conductor 812. Bridge 810 is welded to cathode conductor 118 in a slot formed by alignment slots 710 in cathode assembly 500 at weld point 842. Anode conductor 116 is welded to anode end plate 804 at weld 840. Further, anode end plate 804 is attached to at least one of tabs 728 and 708 with bolts 830 using spacers 822.

FIG. 8B further illustrates assembled battery 100 according to aspects of the present disclosure. As illustrated in FIG. 8B, cathode feedthrough assembly 802 includes cathode bridge 810 that is connected to cathode conductor 118 and a feedthrough conductor 812 connected to the cathode bridge 810. As is illustrated, cathode feedthrough assembly extends through a cathode end plate 808, to which a feedthrough 815 and a fill tube 816 are attached. Further, side wall 826 may be welded to cathode end plate 808 before being mated with assembly 850. Feedthrough 815 is connected to end plate 808 and seals against feedthrough conductor 812. Consequently, FIGS. 8A and 8B illustrate a process where assembly 850 is formed, cathode end cap 808 and sidewall 826 are assembled at weld 842, then assembly 850 is positioned into sidewall 826, which is welded to anode end plate 804 at weld 806.

FIG. 8C illustrates a blow-out view of battery 100 according to some embodiments. As illustrated in FIG. 8C, stack 104 illustrates placement of outer portion 704 and inner portion 702. As illustrated, when stack 104 is assembled it fits within side wall 826 and anode conductor 116 is connected to end plate 804 as is discussed further below. As is further illustrated, a bolt 830 can be inserted through tab 728 and spacer 822 to screw into a mounting hole 832 on anode end plate 804. A similar arrangement can be formed to connect tab 728 to isolator 820. A similar arrangement can be provided with inner portion 702 with tabs 708.

As is further illustrated in FIG. 8C, cathode conductor 118 is connected to cathode feedthrough conductor 812, which is extended through feedthrough 815. An isolator 820 can be placed between cathode conductor 118 and cathode end plate 808 such that feedthrough conductor 812 extends through isolator 820. As is further illustrated, fill tube 816 allows access through cathode end cap 808 to the interior of pressure vessel 102 when cathode end cap 808 is welded to side wall 826 and anode end cap 804 is welded to the opposite side of side wall 826 to form pressure vessel 102.

FIG. 8D further illustrates a partially assembled assembly 850. As illustrated in FIG. 8D, assembled stack 104 is attached to feedthrough assembly 802, which includes cathode feedthrough conductor 812 and cathode bridge 810. FIG. 8D illustrates a view onto plate 732 of outer portion 704. FIG. 8D illustrates wick tabs 828, which represents wick tabs 304, 306, 308, 310, 312, and 314 as illustrated in FIG. 3A. Further, FIG. 8D illustrates anode conductor 118 formed by stacked anode bus bars 214 and cathode conductor 116 formed by stacked cathode bus bars 212. Further, FIG. 8D illustrates how cathode bridge 810 is inserted into a groove formed by the stacked cathode bus bars 212.

FIG. 8E illustrates a side view of stack 104 with cathode feedthrough conductor 812 and cathode bridge 810 attached. As illustrated in FIG. 8E, fingers 726 of outer portion 704 of frame 204 are positioned over fingers 706 of inner portion 702 of frame 204 and welded to hold stack 104 rigid.

FIGS. 8F and 8G illustrate views from each end of stack 104. FIG. 8F illustrates the cathode side and illustrates cathode bridge 810 and cathode feedthrough conductor 812 attached to cathode conductor 116 formed by stacking cathode bus bars 212. FIG. 8G illustrates anode conductor 118.

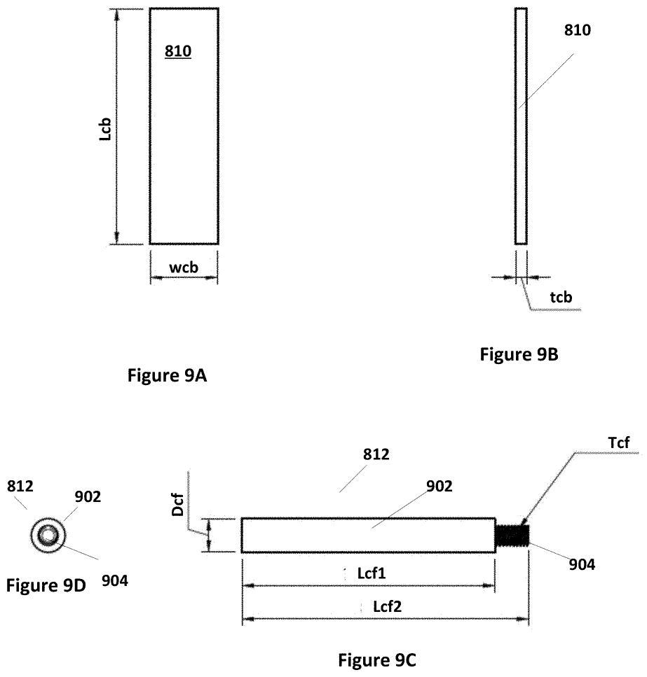

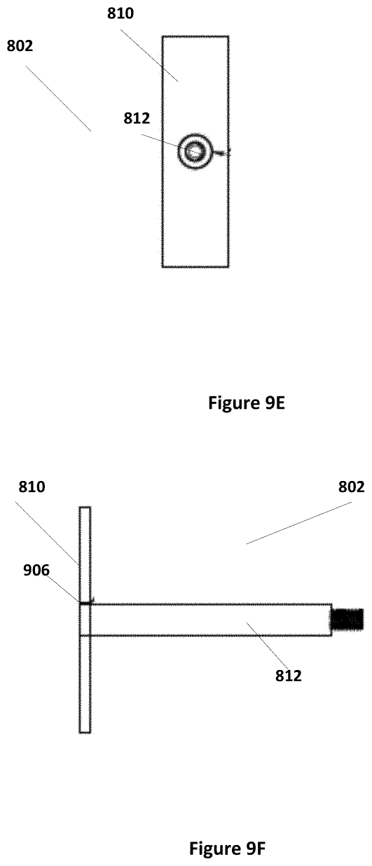

FIGS. 9A and 9B illustrate an example of cathode bridge 810 while FIGS. 9C and 9D illustrate an example of feedthrough conductor 812. As illustrated in FIGS. 9A and 9B, cathode bridge 810 may be formed of a conducting plate of length L_{cb}, width w_{cb}, and thickness t_{cb}. In some embodiments, length L_{cb} and width w_{cb} may be arranged so that plate 810 falls within the indention in cathode conductor 118 formed by alignment slots 510. In a specific example that is consistent with the specific examples provided above, L_{cb}=70.0 mm; w_{cb}=20.0 mm; and t_{cb}=3.175 mm. Although any conducting material consistent with the material used for cathode conductor 118 may be used to form cathode bridge 810, in some embodiments cathode bridge 810 may be formed of nickel.

FIGS. 9C and 9D illustrate an example feedthrough conductor 812. FIG. 9C illustrates the length of feedthrough conductor 812 while FIG. 9D illustrates an end view of feedthrough conductor 812. As illustrated in FIGS. 9C and 9D, feedthrough conductor 812 can be formed of a rod of overall length L_{cf}2 where length L_{cf}1 is of diameter D_{cf} and the remaining (L_{cf}2-L_{cf}1) is threaded to thread specifications T_{cf}. Feedthrough conductor 812 can be formed of any conducting material, for example nickel, that is compatible with the material of conductor cathode conductor 118. As is illustrated in FIG. 8B, feedthrough conductor 812 is attached to cathode bridge 810. In some embodiments, the feedthrough conductor 812 is welded onto bridge 810 as a subassembly 802, which is then placed on the cathode bus 118 and welded to bus bar 212 at notch alignments 510. In one specific example, feedthrough conductor 812 can have dimensions Lcf1=75.0 mm; Lcf2=85.0 mm; Dcf=10.0 mm; and Tcf is M8×1.0.

FIGS. 9E and 9F illustrate the assembled cathode feedthrough assembly 802 according to some embodiments. FIG. 9E illustrates a planar view with feedthrough conductor 812 positioned and welded onto cathode bridge 810. FIG. 9E illustrates a side view of feedthrough assembly 802 with feedthrough conductor 812 positioned and welded at weld 906 to cathode bridge 810.

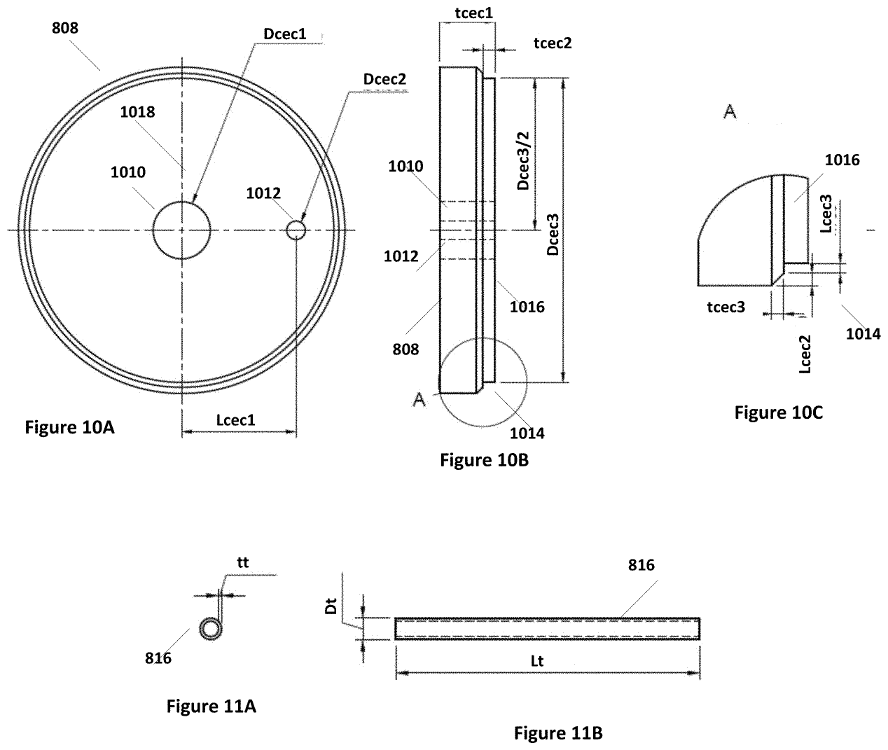

FIGS. 10A, 10B, and 10C illustrate an example of cathode end plate 808. FIG. 10A illustrates a top view of end plate 808. As is illustrated in FIGS. 10A and 10B, cathode end plate 808 is formed from a circular disc. As illustrated in FIG. 10A, end plate 808 includes a through hole 1010 with diameter D_{cec}1 formed in the center of end plate 808 and a through hole 1012 of diameter D_{cec}2 that is offset from the center of through hole 1012 by a distance L_{cec}1. Through hole 1010 allows passage of feedthrough conductor 812 and feedthrough 815 while through hole 1012 allows for fill tube 816.

FIG. 10B illustrates an edge view along line 1018, which is a line that is perpendicular to the line that connects the center of through hole 1010 and through hole 1012 and illustrates a mating edge that can be used to attached to side wall 826. As is illustrated in FIG. 10B, end plate 808 has an overall thickness of t_{cec}1. End plate 808 has an inner diameter of D_{cec}3 at insert 1016 to allow for insertion of insert 1016 into side wall 826. The thickness of the insert 1016 is tcec2. FIG. 10C illustrates a section of the edge view illustrated in FIG. 10B circled by area A. As shown in FIG. 10C, a flat lip over thickness t_{cec}3 and length L_{cec}3 can be formed prior to a tapered portion of length L_{cec}2 to the overall diameter. Consequently, the overall diameter of end plate 808 can be Dcec3+2*Lcec3+2*Lcec2. End plate 808 can be formed of any metallic conductor, in some embodiments end plate 808 can be formed from stainless steel. In a specific example that is consistent with those specific examples provided above, end plate 808 can have the following dimensions: D_{cec}1=20.0 mm; D_{cec}2=6.5 mm; D_{cec}3=106.5 mm; t_{cec}1=19.25 mm; t_{cec}2=4.25 mm; t_{cec}3=2.15 mm; L_{cec}1=40.0 mm; L_{cec}2=2.15 mm; and L_{cec}3=1.74 mm. As discussed above, this specific example is given as an example only and is not intended to be limiting.

FIGS. 11A and 11B illustrate an example of a fill tube 816 according to some aspects. Fill tube 816 can be inserted into through hole 1012 of end plate 808 and welded into place to add electrolyte 126 to pressure vessel 102. As is illustrated in FIG. 11B, fill tube 816 can be a tube of length Lₜ and outer diameter Dₜ. As shown in FIG. 11A, the wall thickness of fill tube 816 can be tt. Any tube that can be sealed within through hole 1012 can be used. In some examples, a metal compatible with that of end plate 808, e.g., stainless steel, can be used. As has been discussed above, once pressure vessel 102 is appropriately filled with electrolyte 125 and then drained, fill tube 816 may be sealed, for example by crimping fill tube 816. In a specific example compatible with that provided above, fill tube 816 can have the following dimensions: Lₜ=90.0 mm; Dₜ=6.350 mm; and tₜ=0.89 mm.

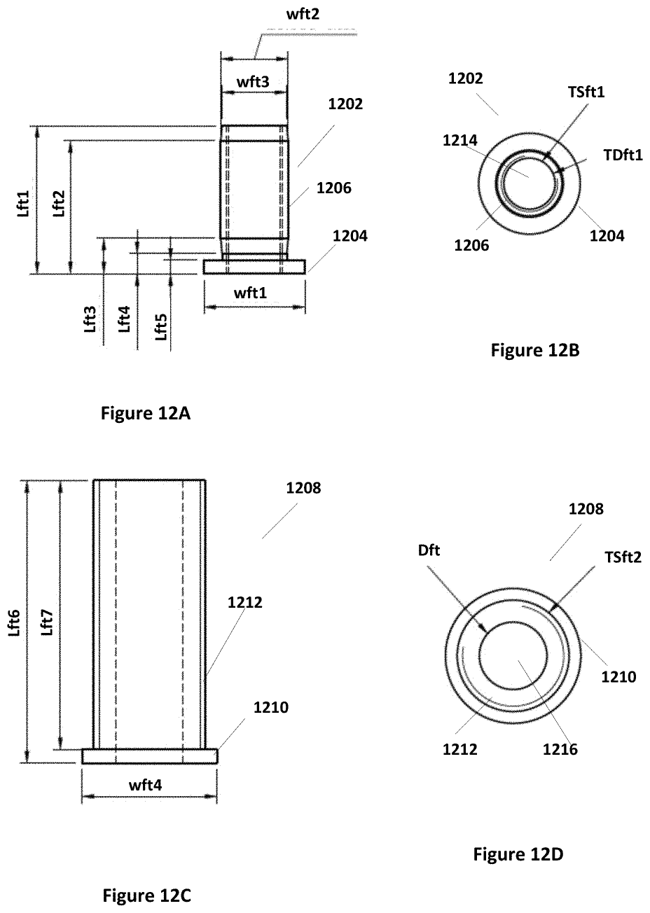

FIGS. 12A, 12B, 12C, and 12D illustrates an embodiment of feedthrough 815 according to some aspects of the present disclosure. Feedthrough 815 includes a body 1202 as illustrated in FIGS. 12A and 12B and an insulator 1208 as illustrated in FIGS. 12C and 12D. Feedthrough 815 is assembled by mating insulator 1208 with body 1202 such that feedthrough conductor 812 extends through insulator 1208 and can be sealed against insulator 1208. Body 1202 can be formed of any material, for example a metal, that can be physically attached and sealed against cathode end cap 808.

As illustrated in FIG. 12A, one example of body 1202, which is cylindrical in shape, can have a length of L_{ft}1. Body 1202 includes a base portion 1204 and a body portion 1206 which are integrated with one another (e.g., formed as a single piece). Base portion 1204 can have a diameter of w_{ft}1 over a length of L_{ft}5. Measured from the bottom of base portion 1204, between a length of L_{ft}3 and L_{ft}2 body portion 1206 has an outer diameter of w_{ft}2. Between the top of base portion 1204 and to a length of L_{ft}4, body portion 1206 has an outer diameter of w_{ft}3. Between length L_{ft}2 and L_{ft}1 and between L_{ft}4 and L_{ft}3, body portion 1206 tapers between a diameter of w_{ft}2 and w_{ft}3. Body 1202 can be positioned over through hole 1010 and welded in place. Further, body 1202 has an interior structure that is configured to receive insulator 1208.

FIG. 12B illustrates a cross-sectional view of body 1202 where body portion 1206 and base portion 1204 are viewed from the top. As is illustrated, a central portion 1204. Central portion 1204 has an inner thread, which can be a standard thread characterized by TS_{ft}1 with a thread depth of TD_{ft}1.

FIGS. 12C and 12D illustrate insulator 1208 of feedthrough 815. Insulator 1208 includes a body portion 1212 and a base portion 1210 and can be formed from an insulating material. As illustrated in FIG. 12C, insulator 1208 has a length of L_{ft}6 while body portion 1212 has a length of L_{ft}7. The diameter of base portion 1210 is w_{ft}4. FIG. 12D illustrates a cross section of insulator 1208. As illustrated in FIG. 12D, an inner through hole 1216 with diameter D_{ft} sized to engage with feedthrough conductor 812. In particular D_{ft} is such as to allow passage of conductor 812 with diameter D_{cf} with sufficient tightness to allow a seal. Further, as is illustrated in FIG. 12D, body portion 1212 has an external thread characterized at TS_{ft}2. In particular, the external thread of body portion 1212 engages with the internal thread of body portion 1206 such that insulator 1208 screws into body 1202. In some embodiments, the internal thread of body portion 1206 and the external thread of insulator 1208 can be pipe threads that provide a seal as they engage with one another.

In a specific example of feedthrough 815 that is consistent with the specific examples discussed above, the following dimensions and characteristics can be used: L_{ft}1=44.0 mm; L_{ft}2=39.5 mm; L_{ft}3=10.5 mm; L_{ft}4=6.0 mm; L_{ft}5=4.0 mm; L_{ft}6=42.0 mm; L_{ft}7=40.0 mm; w_{ft}1=30.0 mm; w_{ft}2=20.0 mm; w_{ft}3=19.2 mm; w_{ft}4=20.0 mm; D_{ft}=10.0 mm; TS_{ft}1=G 3/8-19; TS_{ft}2=G 3/8-19; and TD_{ft}1=0.4 mm. Body 1202 can be metallic and consistent with the material of cathode end plate 808 (e.g., can be welded to or otherwise attached to cathode end plate 808). In some examples, body 1202 can be stainless steel. Insulator 1208 can be any insulator, for example ultra-high molecular weight polyethylene (UHMW) plastic.

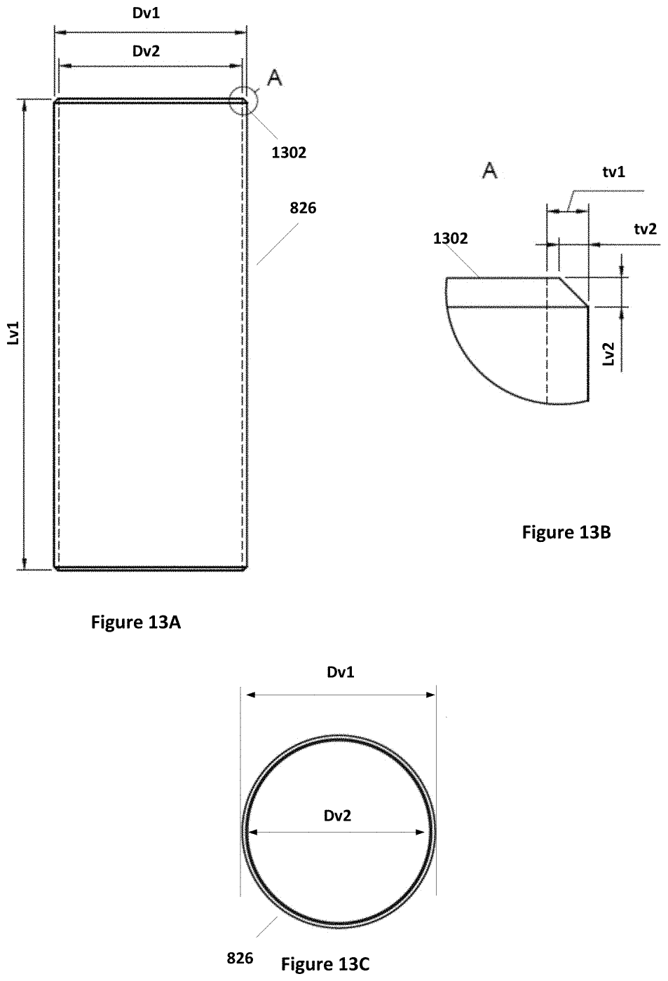

FIGS. 13A, 13B, and 13C illustrates an example of side wall 826 of pressure vessel 102. As shown in FIGS. 13A, side wall 826 is a tube of length Lᵥ1, outer diameter Dᵥ1, and inner diameter Dᵥ2. FIG. 13B illustrates a section of a lip 1302 of side wall 826 enclosed in circle A of FIG. 13A that mates with end caps 804 and 808. As illustrated in FIG. 13B, side wall 826 has a thickness tᵥ1 and is beveled over a length Lᵥ2 and thickness tᵥ2 (<tᵥ1). Lip 1302 is therefore arranged to receive end caps 806 and 808 to form pressure vessel 102. FIG. 13C illustrates a cross section at one end of side wall 826 as illustrated in FIG. 13A. In a specific example consistent with the other specific examples provided above. Lᵥ1=280.0 mm; Lᵥ2=2.15 mm; tᵥ1=3.05 mm; tᵥ2=2.15 mm; Dᵥ1=114.3 mm; and Dᵥ2=108.2 mm.

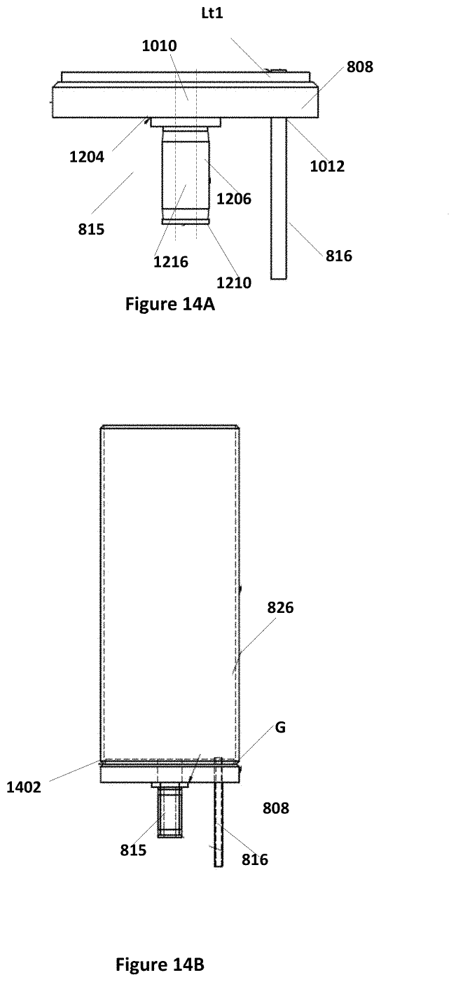

FIGS. 14A and 14B illustrates assembly of cathode end cap 808, fill tube 816, feedthrough 815, and side wall 826 according to some aspects of the present disclosure. As illustrated in FIG. 816, fill tube 816 is inserted into through hole 1012 in cathode end cap 808 and, in some examples, welded in place to seal around fill tube 816. In some examples as illustrated in FIG. 14A, fill tube 816 may extend through cathode end cap 808 by a length Lt1, for example. In a specific example, length Lt1 may be about 1 mm. Additionally, body 1202 of feedthrough 816 can be positioned and welded over through hole 1010 in end cap 808 such that through hole 1010 aligns with inner through hole 1216 of insulator 1208.

In some embodiments, once body 1202 is welded to cathode end plate 808 aligned with through hole 1010, and end plate 808 is welded to side wall 826, insulator 1208 can be screwed into body 1202. During final assembly, cathode end plate 808 is positioned to engage feedthrough conductor 812 so that feedthrough conductor 812 extends through hole 1216. Body portion 1202, particularly the section between length Lft3 and Lft2, can be crushed to both seal insulator 1208 against feedthrough conductor 812 and seal the inner threads of body portion 1206 with the outer threads of body portion 1212.

Crushing of body portion 1202 as described above may occur after end plate 808 is connected and sealed with side wall 826 of pressure vessel 102, as illustrated in FIG. 14B. The lip of end plate 808 as illustrated in FIG. 10C mates with lip 1302 of side wall 826 such that a gap 1402 is formed while end plate 808 is inserted into side wall 826. Gap 1402 may have a gap spacing G while a portion of end plate 808 is inserted within side wall 826, providing for a weld point 842 that can effectively seal end plate 808 to side wall 826. In a specific example, gap G may be about 2 mm and the tapered portions of lips 1302 and 1014 can form, for example, a right-angles.

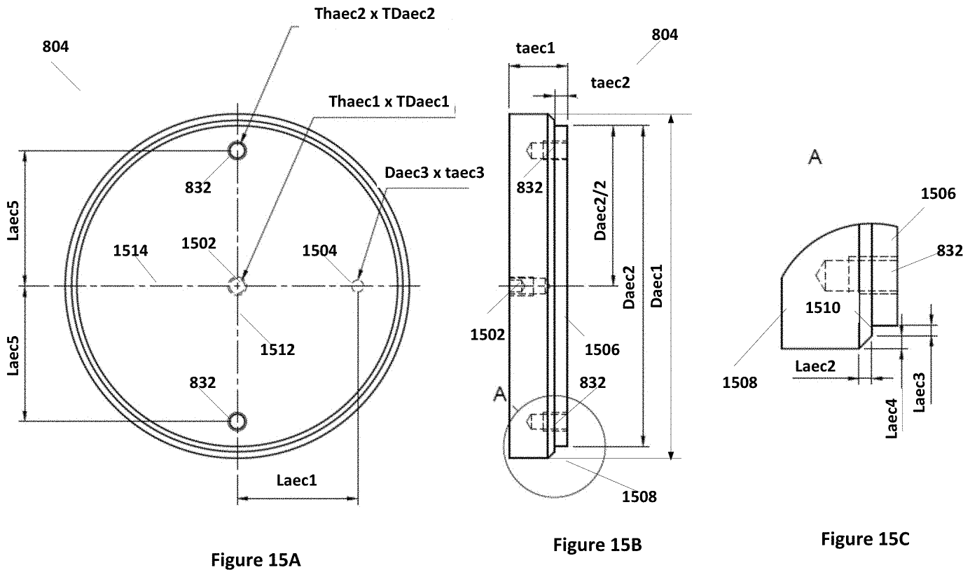

FIGS. 15A, 15B, and 15C illustrate an example of an anode end cap 804 according to some aspects of the present disclosure. As shown in FIGS. 15A and 15B, similar to cathode end cap 808 discussed above, anode end cap 804 is formed of a circular disc of metallic material of diameter D_{aec}1 with a total thickness of t_{aec}1. As shown in FIG. 15B, analog end cap has a lip 1508 that allows analog end cap 804 to engage with side wall 826 to form pressure vessel 102. As shown in FIG. 15B, lip 1508 includes an insert portion 1506 which has a thickness t_{aec}2 and a diameter D_{aec}2. Insert portion 1506, as described above, slides into the interior of side wall 826.

FIG. 15C illustrates lip 1508 within circle A as shown in FIG. 15B. As illustrated in FIG. 15C, lip 1508 includes a flat portion 1510 of length L_{aec}3 and then is tapered to the full diameter D_{aec}1 over length L_{aec}2, tapering in by a length L_{aec}4. Consequently, anode end cap 806 can be inserted into side wall 826 and side wall 836 engages at flat portion 1510.

As is shown in FIG. 15A a tapped hole 1502 is formed in the center of anode end cap 804. Tapped hole 1502 can have thread characteristics Th_{aec}1 and a depth of T_{aec}1, which is less than the overall thickness t_{aec}1. Further, a hole 1504 of depth t_{aec}3 and diameter D_{aec}3 can be formed at a distance L_{aec}1 from the center of tapped hole 1502 along line 1514. Tapped hole 1502 and alignment hole 1504 are formed on a side of anode end cap 804 that is external to pressure vessel 102. Hole 1504 can be an alignment hole that is positioned in a known orientation relative to stack 104 inside the vessel and can be known from outside the vessel during assembly. Further, end cap 804 can include one or more tapped holes 832, as is illustrated in FIG. 8C, to which screws 830 fix end cap 804 through tabs 728 and 708, as discussed above. As shown in FIG. 15A, tapped holes 832 can each be located on line 1512, which is perpendicular to line 1514 and also passes through hole 1502. Tapped holes 832 are spaced a distance L_{aec}5 from hole 1502 on either side of line 1514. Tapped holes 832 are all of depth TD_{aec}2 and has thread type Th_{aec}2.

In a specific example of anode end cap 806, the dimensions can be given by Laec1=40.0 mm; Laec2=2.15 mm; Laec3=1.74 mm; Laec4=2.15 mm; Laec5=45.0 mm; Daec1=114.3 mm; Daec2=106.5 mm; Daec3=4.0 mm; taec1=19.25 mm; taec2=4.25 mm; taec3=4.00 mm; TDaec1=8.0 mm; Thaec1=M6×1 6H; Tdaec2=8.0 mm; and Thaec2=M6×1/6H. Anode end cap 806 can be formed of any material that is compatible with that of side wall 826, for example stainless steel, and engages with sidewall 826 as described above with respect to cathode end cap 808.

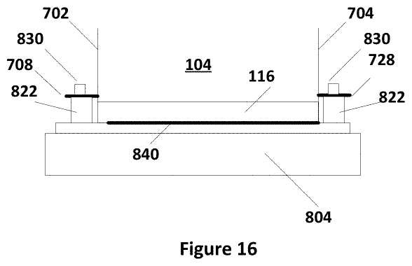

FIG. 16 further illustrates the attachment of stack 104 to anode end cap 804. As illustrated in FIG. 16, stack 104 is first bolted to end cap 804 with a bolt 830 that pass through tabs 708 and 728 of inner portion 702 and outer portion 704, respectively, and through spacer 822. As such, end cap 804 is drilled and tapped appropriately to receive bolt 830 at tapped holes 832. Further, anode conductor 116 is then welded at weld 840 to anode end cap 804.

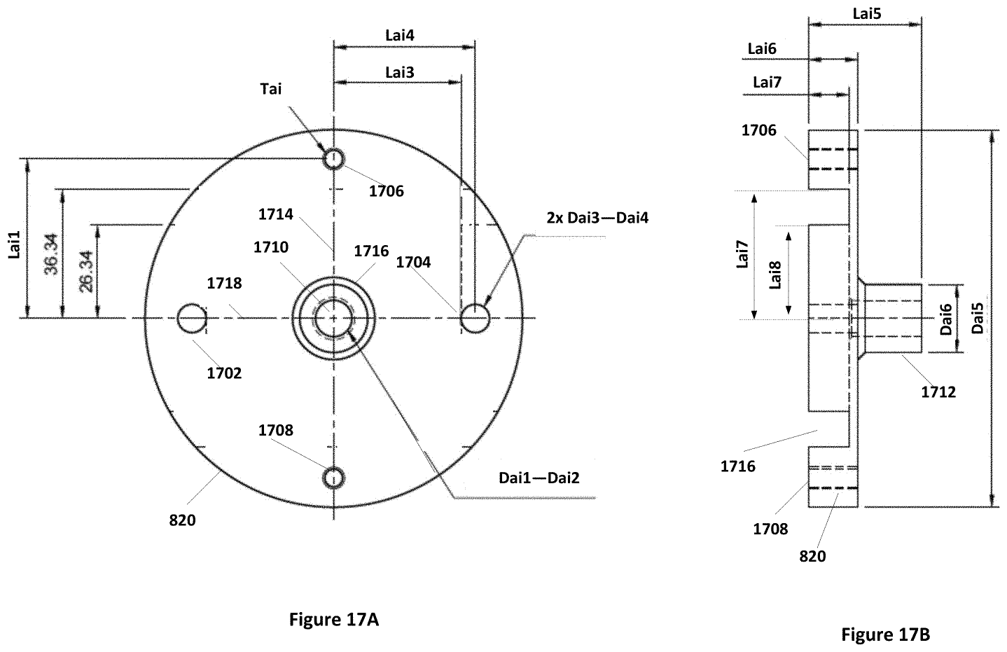

FIGS. 17A and 17B illustrate an example of isolator 820 according to some aspects of this disclosure. Isolator 820 can be any insulating device that can be placed between cathode conductor 118 and cathode end cap 808 through which feedthrough cathode conductor 812 can pass. FIG. 17A illustrates a view of isolator 820 that faces cathode conductor 118 while FIG. 17B illustrates a cross-sectional view through line 1714 illustrated in FIG. 17A. As shown in FIGS. 17A and 17B, isolator 820 is formed of an insulating material of diameter Dₐᵢ5 and primary thickness Lₐᵢ6. A through hole 1710 is formed at the center, the through hole having a diameter Dₐᵢ1 that transitions with a 90° edge to a diameter of Dₐᵢ2. From the view shown in FIG. 17A, the top portion has a larger diameter than the inner portion. Consequently, a protrusion 1712 having an inner diameter Dₐᵢ2 provides a larger thickness Lₐᵢ5 with diameter Dₐᵢ6 is formed over through hole 1710. The center through hole, of diameter Dₐᵢ2, is arranged to accept the anode feedthrough conductor 824. In some examples, protrusion 1712 can be formed integrated with isolator 820 while in some examples, protrusion 1712 can be formed separately and inserted into through hole 1710 using the lip formed between diameter Dₐᵢ1 and Dₐᵢ2. Protrusion 1712 may, in some examples, be close, or in contact with, cathode end cap 806 such that when cathode feedthrough conductor 812 is substantially covered from cathode conductor 118 through feedthrough 815.

As is further shown in FIG. 17A, two through holes 1702 and 1704 are positioned along a center line, which is perpendicular to the line 1714, at a distance of Lₐᵢ4 from the center of through hole 1710. Holes 1702 and 1704 prevent isolator 820 from blocking inflow of electrolyte 126, and thereby allow electrolyte 126 to flow from fill tube 122 into vessel 102. As is illustrated, through holes 1702 and 1704 have a diameter Dₐᵢ3 that may, in some cases, transition in a 90° ledge to a diameter of Dₐᵢ4. Consequently, the inner side wall of the inner diameter Dₐᵢ4 is at a length Lₐᵢ3 from the center of through hole 1710.

As is further illustrated in FIG. 17A tapped holes 1706 and 1708 can be formed along line 1714. Holes 1706 and 1708 can be formed appropriately to receive a bolt 830 through tabs 728 and 708 of frame 204. As such, holes 1706 and 1708 can be tapped according to the parameters Tai. The depth of holes 1706 and 1708 can be Lₐᵢ7. Further, as shown in FIG. 17B, a chamfer 1716 can be formed on the bottom of isolator 820. Chamfer 1716 can have an inner diameter of Lₐᵢ8 and an outer diameter Lₐᵢ7 and depth of Lₐᵢ7 and is centered on through hole 1710.

A specific example of isolator 820 that is consistent with other specific examples provided above can have the following dimensions: Lₐᵢ1=45.0 mm; Lₐᵢ3=36.0 mm; Lₐᵢ4=40.0 mm; Lₐᵢ5=32.0 mm; Lₐᵢ6=14.0 mm; Lₐᵢ7=11.5 mm; Tₐᵢ=M6×1 6H; Dₐᵢ1=12.0 mm; Dₐᵢ2=10.3 mm; Dₐᵢ3=8.0 mm; Dₐᵢ4=10.0 mm; Dₐᵢ5=106.53 mm; and Dₐᵢ6=19.2 mm. Isolator 820 can be any insulating material, for example UHMW plastic.

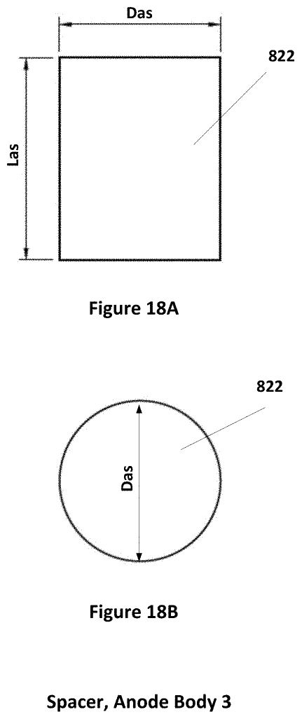

FIGS. 18A and 18B illustrates an example of spacer 822. As illustrated, spacer 822 is a cylindrical shape of length Las and diameter Das. Spacer 822 can be formed of any material, for example stainless steel. In a specific example, spacer 822 can have the following dimensions: Las=12.0 mm and Das=9.5 mm.

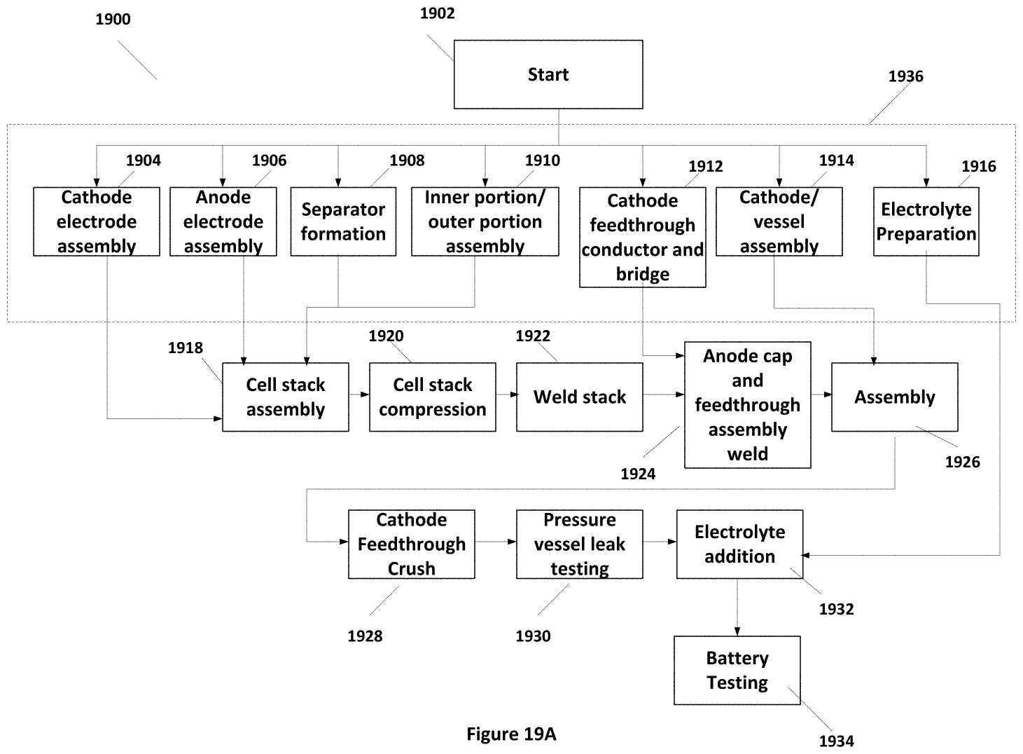

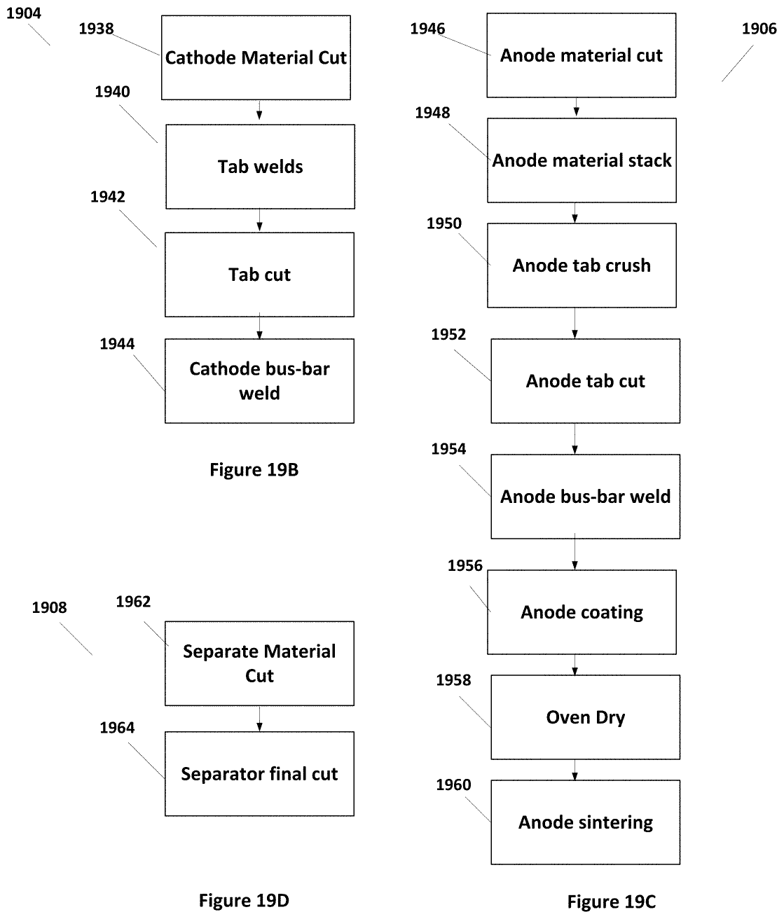

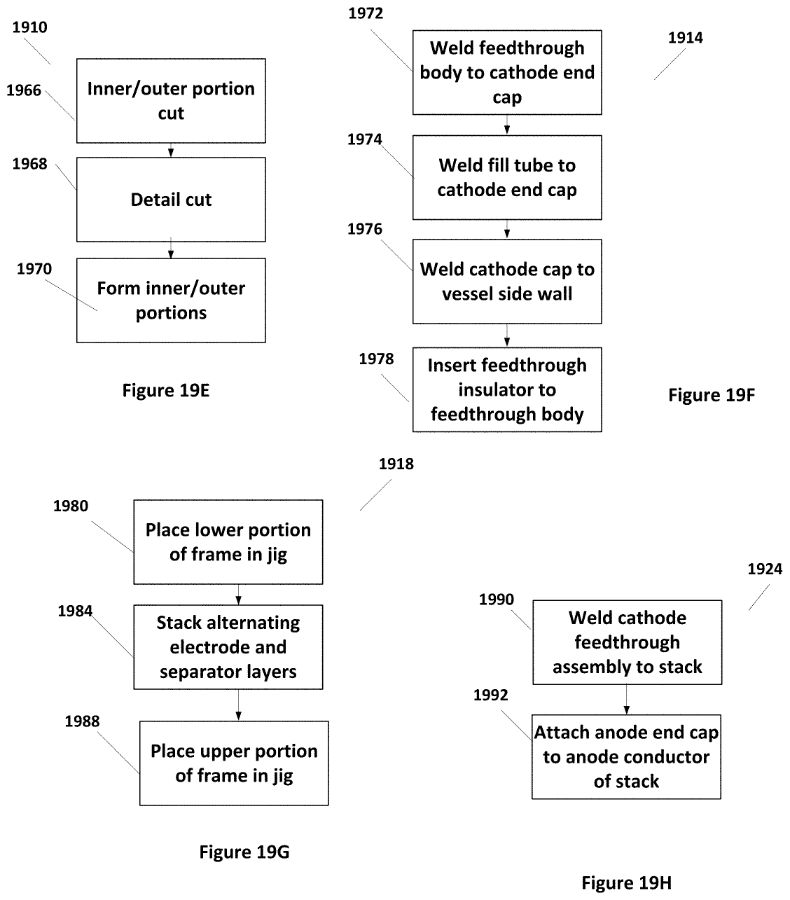

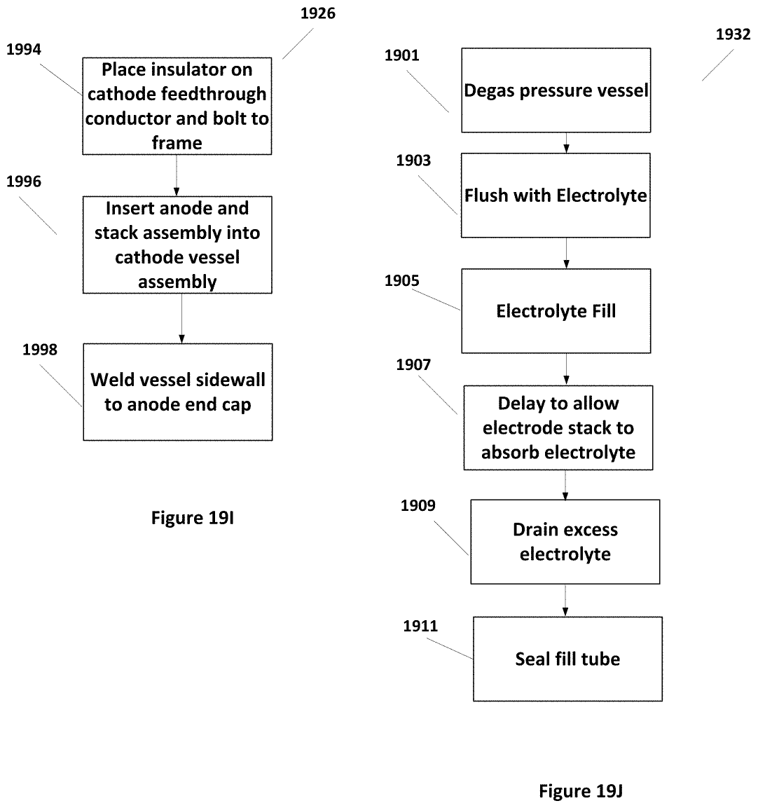

FIGS. 19A through 19E illustrate a method 1900 for producing a battery 100 according to some embodiments of the present disclosure. As is illustrated in FIG. 19A, method 1900 starts at step 1902 and proceeds to block 1936, which includes a series of pre-assemblies that can be performed prior to assembly of battery 100. Preassembly step 1936 can include cathode electrode assembly step 1904, anode electrode assembly 1906, separator formation 1908, frame component (inner portion/outer portion) assembly 1910, feedthrough assembly 1912, cathode/vessel assembly 1914, and electrolyte preparation 1916. Each of these steps can be performed in parallel and are not dependent on completion of the others.

In cathode electrode assembly step 1904, cathode assembly 500 is assembled as described above with respect to FIGS. 5A through 5F. As described, cathode material layers 582 are prepared, each with a tab 514, and affixed to a cathode bus bar 212, for example by a resistive spot-welding process. As a result of cathode electrode assembly 1904, sufficient numbers of cathode assemblies 500 can be prepared for assembly of battery 100. Step 1904 is illustrated in more detail in FIG. 19B.

As illustrated in FIG. 19B, cathode electrode assembly step 1904 begins in step 1938 where the cathode material is cut to form cathode material layers 502 as illustrated in FIGS. 5A through 5D. In step 1940, tabs 514 are welded to cathode material layers 502, if they are not already present with the cathode material sheets. In step 1942, tabs 514 can be cut to form alignments 520, 522, and 524 as illustrated in FIG. 5D. In step 1944, the cathode bus bar 212 as illustrated in FIG. 5E is attached to tabs 514 of a plurality of layers 502, for example two layers, to form cathode assembly 500. Tabs 514, for example, may be spot welded to two layers 504 to form cathode assembly 500.

In anode electrode assembly step 1906, anode assembly 400 is assembled as described above with respect to FIGS. 4A through 4F. As illustrates in FIGS. 4A through 4B, anode layers 402 and 420 are formed, the materials are stacked and compressed to form tab 404, and anode bus bar 214 is attached to form anode assembly 400. Sufficient numbers of anode assemblies 400 can be produced to form a battery 100. The process of forming anode assemblies 400 is further illustrated with respect to FIG. 19C.

As shown in FIG. 19C, step 1906 starts with step 1946. In step 1946, the anode material is cut to form layers 402 and 420. It should be noted that layers 402 and 420 may be cut from different sheets of anode material, for example anode layer 420 may be corrugated while layers 402 are not. In step 1948, the anode material layers 402 and 420 are stacked. In one example, two layers 402 are separated by a layer 420. In step 1950, the stacked anode material is crushed to form tab 404 as illustrated in FIG. 4C. In step 1952, alignment holes 406 and 408 are cut in tab 404 as illustrated in FIG. 4D. In step 1954, anode bus bar 214, which is illustrated in FIG. 4E, is positioned and welded to tab 404 to form anode assembly 400. In step 1956, the anode assembly 400 may be coated, for example with PTFE. If so, then in step 1958, anode assembly 400 is oven dried. In some embodiments, this step may take several hours (e.g., four (4) hours). In step 1960, anode assembly 400 may be sintered. Step 1960 may also take several hours (e.g., 7-8 hrs). At the conclusion of step 1906, anode assembly 400 is formed.

In separator formation 1908, separator 110 is formed as illustrated in FIGS. 3A and 3B. As discussed with respect to FIGS. 3A and 3B involves cutting separator 110 from a sheet of separator material. Sufficient numbers of separator 110 can be formed to produce battery 100. The separator formation step 1908 is further illustrated in FIG. 19D. As illustrated in FIG. 19D, in step 1962 the outside shape of separator 110 with wicks 304, 306, 308, 310, 312, and 314 is cut from a sheet of separator material. In step 1964, features such as alignment holes 316, 318, 320, 322, 324, and 326 can be formed.

In step 1910, inner portion 702 and outer portion 704 of frame 204 is formed as discussed in FIGS. 7A through 7H. As discussed above, inner portion 702 and outer portion 704 can be formed by cutting them from a sheet of metal and bending to form fingers 706 and 726 and tabs 708 and 728. Alternatively, fingers 706 and 726 may be formed separately and welded to form inner portion 702 and outer portion 704 as described above. FIG. 19E illustrates one example of step 1910.

As illustrated in FIG. 19E, step 1920 beings with a cut of a metallic sheet to form components of the inner portion 702 and outer portion 704 in step 1966. This may include forming fingers 706 and 726 as well as tabs 708 and 728. In step 1968, fine features may be formed in each of inner portion 702 and outer portion 704, for example holes 740 in fingers 726, holes 718 and 738 in tabs 708 and 728, respectively, and other features as illustrated in FIGS. 7A through 7H. In step 1970, the features that have been cut from the metallic sheet can be bent into position to form inner portion 702 and outer portion 704 as, for example, described above with respect to FIGS. 7A through 7H.

In step 1912 cathode feedthrough assembly 802 is formed as described in FIGS. 9A through 9F. As described, cathode feedthrough assembly 802 includes bridge 810 welded to feedthrough conductor 812.

In step 1914, a vessel/cathode assembly is formed as is illustrated in FIGS. 14A and 14B. In step 1914, feedthrough body 1202 and fill tube 816 are welded to cathode end cap 808 and then end cap 808 is welded to side wall 826. An example of step 1914 is illustrated in FIG. 19F. As illustrated in FIG. 19F, in step 1972 base portion 1204 of body 1202 of feedthrough 816 is welded to cathode end cap 808 as illustrated in FIG. 14A to through hole 1010 as illustrated in FIG. 10A. In step 1974, fill tube 816 is welded into hole 1012 of cathode end cap 808. In step 1976, cathode end cap 808 is then welded to vessel side wall 826 as illustrated in FIG. 14B. Finally, in step 1978, insulator 1208 of feedthrough 815 is inserted into body 1202 of feedthrough 815.

In step 1916, the electrolyte 126 is prepared. The electrolyte 126 can be a KOH electrolyte as described above.

Once the components are prepared in step 1936, then method 1900 proceeds to step 1918. In step 1936, as shown in FIG. 6B, a number of cathode assemblies 500 as formed in step 1904, a number of anode assemblies 400 as formed in step 1906, a number of separators 110 as formed in step 1908, an inner portion 702 and an outer portion 704 as formed in step 1910 are stacked within a jig 602. In particular, one example of step 1918 is illustrated in FIG. 19G.

As illustrated in FIG. 19G, step 1918 begins in step 1980 where a lower portion 222 of frame 204 is positioned jig 602. In some embodiments, for example, lower portion 222 can be inner portion 702 in other embodiments lower portion 222 can be outer portion 704. In step 1984, alternating layers of cathode assemblies 500, separators 110, and anode assemblies 400 are positioned on jig 602. As discussed above, in a particular example electrode stack may include twenty (21) anode assemblies 400 (each with two anode material layers 402 and an anode material layer 420) and twenty (20) cathode assemblies 500 (each with two cathode layers 502). Anode assemblies 400 and cathode assemblies 500 can be separated by separators 110, formed of one or more separator layers 300 as illustrated in FIGS. 3A and 3B. In this particular example, the top and bottom layers are anode assemblies 400. As discussed above, in some examples top and bottom layers may be separators 110 Finally, in step 1988, upper portion 220 of frame 204 is placed over the stacked electrodes on jig 602. Once all of the components have been positioned on jig 602, then method 1900 proceeds from step 1918 to step 1920.

In step 1920, as illustrated in FIG. 6C, the jig 602 with the components positioned in a press 630 and pressure is applied to the stacked components. As illustrated in FIG. 6C, jig 602 includes alignments rods 620 that insert into sleeves 634 of press 630 to allow for application of pressure to the stack. In one example, 0.58 MPa of pressure can be applied, although other pressure levels can also be used. While the pressure is being applied in step 920, method 1900 proceeds to step 1922.

In step 1922, as is illustrated in FIG. 6C, outer fingers 726 of outer portion 704 are welded to inner fingers 706 of inner portion 702 using holes 740 in outer fingers 726. In FIG. 6C, these welds are shown as welds 636. Further, anode buses 214 of each of anode assemblies 400 are welded together at weld 640 to form conductor 116 and cathode buses 212 for each of cathode assemblies 500 are welded together at weld 638 to form conductor 118. Once step 1922 is complete, then stack 104 can be removed from press 630 and jig 602 and method 1900 proceeds to step 1924.

In step 1924, assembly 850 as illustrated in FIG. 8A is formed. An example of step 1924 is illustrated in FIG. 19H. In step 1990, cathode feedthrough assembly 800 is welded to stack 104, as is illustrated in FIGS. 8A, 8D, 8E, and 8F. As illustrated, cathode feedthrough assembly 800 includes a bridge 810 that is welded within a slot formed by alignments 510 in stacked cathode bus bars 212 forming cathode conductor 116. In step 1992, anode end cap 804 is mounted to anode conductor 118. An example of this attachment is illustrated in FIGS. 8C and 16, where anode conductor 118 is first bolted to tabs 708 and 728 of inner portion 702 and outer portion 704, respectively, and welded at weld 840 to anode conductor 116. Once assembly 850 is formed in step 1924, then method 1900 can proceed to final assembly 1926.

In step 1926, the cathode and vessel assembly as produced in step 1914 and assembly 850 as produced in step 1924 can be combined as illustrated in FIGS. 8B and 8C. Step 1926 is further illustrated in FIG. 19I. As illustrated in FIG. 19I, step 1926 starts with step 1994, where insulator 820 is placed onto cathode feedthrough conductor 812 of assembly 802 and is bolted to tabs 708 of inner portion 702 and 728 of outer portion 704 as discussed with respect to FIGS. 17A and 17B. In step 1996, assembly 850 with insulator 820 in place is inserted through sidewall 826 such that cathode feedthrough conductor 812 extends through feedthrough 815. In step 1998, sidewall 826 is welded to anode end cap 804. From step 1926, method 1900 proceeds to step 1928.

In step 1928, outer body portion 1206 of body 1202 is crushed, or crimped, so that insulator 1208 seals around cathode feedthrough conductor 812. Step 1928 is accomplished by evenly crimping body portion 1208 around its circumference to provide an even seal around cathode feedthrough conductor 812. After step 1928, pressure vessel 102 is complete. Once step 1928 is complete, then method 1900 proceeds to step 1930.

In step 1930, pressure vessel 102 is leak tested using fill tube 816. In this step, pressure testing can be performed by pressurizing pressure vessel 102 to a particular test pressure and monitoring pressure over time. Pressure vessel 102 can be determined to pass the test if pressure holds for a set period of time. If pressure vessel 102 passes the leak test, then method 1900 proceeds to step 1932.

In step 1932, electrolyte 126 produced in electrolyte preparation step 1916 is added to pressure vessel 102. An example of step 1932 is illustrated in FIG. 19J. As shown in FIG. 19J, step 1932 starts with degas step 1901. In degas step 1901, pressure vessel 102 is evacuated through fill tube 816 to allow the interior to allow for degas. In step 1903, pressure vessel 102 may be flushed one or more times with electrolyte 126 by filling and draining pressure 102 one or more times through fill tube 816. Filling and draining may include evacuating pressure vessel 102 and filling pressure vessel 102 with electrolyte then applying gas at a pressure to drain pressure vessel 102. In step 1905, electrolyte 126 is added to pressure vessel 102 to fill pressure vessel 102. This can be accomplished, as discussed above, by repeatedly evacuating pressure vessel 102 and adding electrolyte 126 until pressure vessel 102 is filled with electrolyte 126. In step 1907, pressure vessel 102, now filled with electrolyte 126, is allowed to sit for a period of time to allow electrode stack 104 to absorb a sufficient amount of electrolyte 126 for operation of battery 100. In some embodiments, this step may be sufficiently long to saturate electrode stack 104 with electrolyte 126. Once electrode stack 104 contains sufficient electrolyte 126, which may take several hours (e.g. about 8 hrs) overall, then step 1932 proceeds to step 1909 where excess electrolyte 126 is drained. This can be accomplished by providing a pressure of hydrogen gas to fill tube 816 to remove excess electrolyte 126. In step 1911, fill tube 816 is sealed to form a completed battery 100. From step 1932, method 1900 proceeds to step 1934 for electrical testing. Electrical testing in step 1934 may include charging and discharging the resulting battery 100 over several cycles and monitoring performance of battery 100.

Aspects of the present disclosure describe a metal hydrogen battery and its assembly. A selection of the multitude of aspects of the present invention can include the following aspects:

Aspect 1: A metal hydrogen battery, comprising: an electrode stack, the electrode stack including alternating anode assemblies and cathode assemblies, the anode assemblies and cathode assemblies separated by a separator, each of the anode assemblies including at least one anode layer connected to an anode bus, each of the cathode assemblies including at least one cathode layer connected to a cathode bus, wherein each of the anode buses are electrically and mechanically attached to form an anode conductor, and wherein each of the cathode buses are electrically and mechanically attached to form a cathode conductor; a pressure vessel, the pressure vessel including a side wall, a cathode end plate, and an anode end plate, the electrode stack inserted within the pressure vessel; and an electrolyte contained within the electrode stack.

Aspect 2: The metal hydrogen battery of Aspect 1, further including a feedthrough that attaches to the cathode end plate; and a cathode feedthrough conductor that attaches to the cathode conductor and extends through the feedthrough.

Aspect 3: The metal hydrogen battery of Aspects 1-2, wherein the feedthrough includes a body portion that attaches to the cathode end plate and an insulator portion that inserts into the body portion and engages the cathode feedthrough conductor.

Aspect 4: The metal hydrogen battery of Aspects 1-3, wherein the body portion is crushed to form seals between the body portion, the insulator portion, and the cathode feedthrough conductor.

Aspect 5: The metal hydrogen battery of Aspects 1-4, further including an isolator positioned between the cathode conductor and the cathode end plate.

Aspect 6: The metal hydrogen battery of Aspects 1-5, wherein the anode end plate is directly attached to the anode conductor.

Aspect 7: The metal hydrogen battery of Aspects 1-6, wherein the anode end plate is welded to the anode conductor.

Aspect 8: The metal hydrogen battery of Aspects 1-7, wherein the electrode stack further includes a frame surrounding the alternating anode assemblies and cathode assemblies, the electrode stack being welded while the electrode stack is pressed.

Aspect 9: The metal hydrogen battery of Aspects 1-8, wherein the alternating anode assemblies and cathode assemblies of the electrode stack includes one more anode assembly than cathode assemblies, wherein the electrode stack includes an anode assembly on each side of the electrode stack.

Aspect 10: The metal hydrogen battery of Aspects 1-9, wherein the separator includes one or more separator layers.

Aspect 11: The metal hydrogen battery of Aspects 1-10, wherein the separator includes wick tabs.

Aspect 12: A method of forming a metal hydrogen battery, comprising:

preassembling components of the metal hydrogen battery by assembling a plurality of cathode assemblies, each cathode assembly having a cathode bus bar attached to one or more cathode material layers, assembling a plurality of anode assemblies, each anode assembly having a cathode bus bar coupled to one or more anode material layers, forming separators from one or more separator layers, forming frame inner portions and frame outer portions, at least one of the frame inner portion and frame outer portion including fingers that connect the frame inner portion and the frame outer portion, assembling a cathode feedthrough assembly that includes a bridge welded to a cathode feedthrough conductor, assembling a cathode vessel assembly that include a cathode end cap, a feedthrough connected to the cathode end cap, a fill tube connected to the cathode end cap, and a vessel sidewall attached to the cathode end cap, wherein the feedthrough includes a body and an insulator, and preparing an electrolyte; stacking the frame inner portion, the frame outer portion, separators, anode assemblies, and cathode assemblies in a jig to capture the electrodes between the frame inner portion and the frame outer portion; pressing the electrodes, the frame inner portion, and the frame outer portion in the jig; forming an electrode stack by, while pressure is applied, attaching the frame inner portion to the frame outer portion with the fingers to form a frame, attaching the anode bus bars of the plurality of anode assemblies to form an anode conductor, and attaching the cathode bus bars of the plurality of cathode assemblies to form a cathode conductor; assembling an anode assembly by attaching the anode end cap to the anode conductor of the electrode stack, and attaching the cathode feedthrough assembly to the cathode conductor of the electrode stack; inserting an insulator over the cathode feedthrough conductor; inserting the anode assembly into the vessel side wall of the cathode vessel assembly by inserting the cathode feedthrough conductor through the feedthrough of the cathode end cap; attaching the anode end cap of the anode assembly to the vessel side wall of the cathode vessel assembly; crushing the feedthrough body to seal the insulator of the feedthrough against the cathode feedthrough conductor; adding electrolyte to the electrode stack through the fill tube; and sealing the fill tube.

Aspect 13: The method of Aspect 12, wherein the fill tube extends through the cathode end cap.

Aspect 14: The method of Aspects 12-13, wherein forming a plurality of anode assemblies comprises: for each anode assembly of the plurality of anode assemblies, forming one or more anode material layers from sheets of anode material; stacking the one or more anode material layers; crushing an end of the stacked anode material layers to form a tab; and attaching an anode bus bar to the tab.

Aspect 15: The method of Aspects 12-14, wherein assembling a plurality of cathode assemblies comprises: for each cathode assembly of the plurality of cathode assemblies, forming one or more cathode layers from sheets of cathode material; attaching a tab to each of the one or more cathode layers; the tabs of the one or more cathode layers to a cathode bus bar.

Aspect 16: The method of Aspects 12-15, wherein assembling the cathode vessel assembly comprises: attaching the body of the feedthrough to align with a through hole in the cathode end cap; attaching the fill tube to a second through hole in the cathode end cap; attaching the vessel sidewall to the cathode end cap; and inserting the insulator of the feedthrough into the body of the feedthrough.

Aspect 17: An electrode stack for a hydrogen metal battery, comprising: an electrode stack, the electrode stack including alternating anode assemblies and cathode assemblies, the anode assemblies and cathode assemblies separated by a separator, each of the anode assemblies including at least one anode layer connected to an anode bus, each of the cathode assemblies including at least one cathode layer connected to a cathode bus, wherein each of the anode buses are electrically and mechanically attached to form an anode conductor, and wherein each of the cathode buses are electrically and mechanically attached to form a cathode conductor.

Aspect 18: The electrode stack of Aspect 17, wherein the electrode stack further includes a frame surrounding the alternating anode assemblies and cathode assemblies, the electrode stack being welded while the electrode stack is pressed.

Aspect 19: The electrode stack of Aspect 17-18, wherein the alternating anode assemblies and cathode assemblies of the electrode stack includes one more anode assemblies than cathode assemblies, wherein the electrode stack includes an anode assembly on each side of the electrode stack.

Aspect 20: The electrode stack of Aspects 17-19, wherein the separator includes one or more separator layers.

Aspect 21: The electrode stack of Aspects 17-20, wherein the separator includes wick tabs.

Aspect 22: A method of forming an electrode stack for a metal hydrogen battery, comprising: preassembling components of the metal hydrogen battery by assembling a plurality of cathode assemblies, each cathode assembly having a cathode bus bar attached to one or more cathode material layers, assembling a plurality of anode assemblies, each anode assembly having an anode bus bar coupled to one or more anode material layers, forming separators from separator material, forming frame inner portions and frame outer portions, at least one of the frame inner portion and frame outer portion including fingers that connect the frame inner portion and the frame outer portion; stacking the frame inner portion, the frame outer portion, separators, anode assemblies, and cathode assemblies to capture the electrodes between the frame inner portion and the frame outer portion; pressing the electrodes, the frame inner portion, and the frame outer portion; forming an electrode stack by, while pressure is applied, attaching the frame inner portion to the frame outer portion with the fingers to form a frame, attaching the anode bus bars of the plurality of anode assemblies to form an anode conductor, and attaching the cathode bus bars of the plurality of cathode assemblies to form a cathode conductor.

Embodiments of the invention described herein are not intended to be limiting of the invention. One skilled in the art will recognize that numerous variations and modifications within the scope of the present invention are possible. Consequently, the present invention is set forth in the following claims.

What is claimed is:

1. A metal hydrogen battery, comprising:
an electrode stack, the electrode stack including alternating anode assemblies and cathode assemblies, the anode assemblies and cathode assemblies separated by a separator, each of the anode assemblies including at least one anode layer connected to an anode bus, each of the cathode assemblies including at least one cathode layer connected to a cathode bus, wherein each of the anode buses are electrically and mechanically attached to form an anode conductor, and wherein each of the cathode buses are electrically and mechanically attached to form a cathode conductor;
a pressure vessel, the pressure vessel including a side wall, a cathode end plate, and an anode end plate, the electrode stack inserted within the pressure vessel; and
an electrolyte contained within the electrode stack.

2. The metal hydrogen battery of claim 1, further including
a feedthrough that attaches to the cathode end plate; and
a cathode feedthrough conductor that attaches to the cathode conductor and extends through the feedthrough.

3. The metal hydrogen battery of claim 2, wherein the feedthrough includes a body portion that attaches to the cathode end plate and an insulator portion that inserts into the body portion and engages the cathode feedthrough conductor.

4. The metal hydrogen battery of claim 3, wherein the body portion is crushed to form seals between the body portion, the insulator portion, and the cathode feedthrough conductor.

5. The metal hydrogen battery of claim 1, further including
an isolator positioned between the cathode conductor and the cathode end plate.

6. The metal hydrogen battery of claim 1, wherein the anode end plate is directly attached to the anode conductor.

7. The metal hydrogen battery of claim 6, wherein the anode end plate is welded to the anode conductor.

8. The metal hydrogen battery of claim 1, wherein the electrode stack further includes a frame surrounding the alternating anode assemblies and cathode assemblies, the electrode stack being welded while the electrode stack is pressed.

9. The metal hydrogen battery of claim 1, wherein the alternating anode assemblies and cathode assemblies of the electrode stack includes one more anode assemblies than cathode assemblies, wherein the electrode stack includes an anode assembly on each side of the electrode stack.

10. The metal hydrogen battery of claim 1, wherein the separator includes one or more separator layers.

11. The metal hydrogen battery of claim 1, wherein the separator includes wick tabs.

12. A method of forming a metal hydrogen battery, comprising:
preassembling components of the metal hydrogen battery by
assembling a plurality of cathode assemblies, each cathode assembly having a cathode bus bar attached to one or more cathode material layers,
assembling a plurality of anode assemblies, each anode assembly having a cathode bus bar coupled to one or more anode material layers,
forming separators from one or more separator layers,
forming frame inner portions and frame outer portions, at least one of the frame inner portion and frame outer portion including fingers that connect the frame inner portion and the frame outer portion,
assembling a cathode feedthrough assembly that includes a bridge welded to a cathode feedthrough conductor,
assembling a cathode vessel assembly that include a cathode end cap, a feedthrough connected to the cathode end cap, a fill tube connected to the cathode end cap, and a vessel sidewall attached to the cathode end cap, wherein the feedthrough includes a body and an insulator, and
preparing an electrolyte;
stacking the frame inner portion, the frame outer portion, separators, anode assemblies, and cathode assemblies to capture the electrodes between the frame inner portion and the frame outer portion;
pressing the electrodes, the frame inner portion, and the frame outer portion;
forming an electrode stack by, while pressure is applied,
attaching the frame inner portion to the frame outer portion with the fingers to form a frame,
attaching the anode bus bars of the plurality of anode assemblies to form an anode conductor, and
attaching the cathode bus bars of the plurality of cathode assemblies to form a cathode conductor;
assembling an anode assembly by attaching the anode end cap to the anode conductor of the electrode stack, and attaching the cathode feedthrough assembly to the cathode conductor of the electrode stack;
inserting an insulator over the cathode feedthrough conductor;
inserting the anode assembly into the vessel side wall of the cathode vessel assembly by inserting the cathode feedthrough conductor through the feedthrough of the cathode end cap;
attaching the anode end cap of the anode assembly to the vessel side wall of the cathode vessel assembly;
crushing the feedthrough body to seal the insulator of the feedthrough against the cathode feedthrough conductor;
adding electrolyte to the electrode stack through the fill tube; and
sealing the fill tube.

13. The method of claim 12, wherein the fill tube extends through the cathode end cap.

14. The method of claim 12, wherein forming a plurality of anode assemblies comprises:
for each anode assembly of the plurality of anode assemblies,
forming one or more anode material layers from sheets of anode material;
stacking the one or more anode material layers;
crushing an end of the stacked anode material layers to form a tab;
attaching an anode bus bar to the tab.

15. The method of claim 12, wherein assembling a plurality of cathode assemblies comprises:
for each cathode assembly of the plurality of cathode assemblies,
forming one or more cathode layers from sheets of cathode material;
attaching a tab to each of the one or more cathode layers;
the tabs of the one or more cathode layers to a cathode bus bar.

16. The method of claim 12, wherein assembling the cathode vessel assembly comprises:
attaching the body of the feedthrough to align with a through hole in the cathode end cap;
attaching the fill tube to a second through hole in the cathode end cap;
attaching the vessel sidewall to the cathode end cap; and
inserting the insulator of the feedthrough into the body of the feedthrough.

17. An electrode stack for a hydrogen metal battery, comprising:
an electrode stack, the electrode stack including alternating anode assemblies and cathode assemblies, the anode assemblies and cathode assemblies separated by a separator, each of the anode assemblies including at least one anode layer connected to an anode bus, each of the cathode assemblies including at least one cathode layer connected to a cathode bus, wherein each of the anode buses are electrically and mechanically attached to form an anode conductor, and wherein each of the cathode buses are electrically and mechanically attached to form a cathode conductor.

18. The electrode stack of claim 17, wherein the electrode stack further includes a frame surrounding the alternating anode assemblies and cathode assemblies, the electrode stack being welded while the electrode stack is pressed.

19. The electrode stack of claim 17, wherein the alternating anode assemblies and cathode assemblies of the electrode stack includes one more anode assemblies than cathode assemblies, wherein the electrode stack includes an anode assembly on each side of the electrode stack.

20. The electrode stack of claim 17, wherein the separator includes one or more separator layers.

21. The electrode stack of claim 17, wherein the separator includes wick tabs.

22. A method of forming a electrode stack for a metal hydrogen battery, comprising:
preassembling components of the metal hydrogen battery by
assembling a plurality of cathode assemblies, each cathode assembly having a cathode bus bar attached to one or more cathode material layers,
assembling a plurality of anode assemblies, each anode assembly having an anode bus bar coupled to one or more anode material layers,
forming separators from separator material,
forming frame inner portions and frame outer portions, at least one of the frame inner portion and frame outer portion including fingers that connect the frame inner portion and the frame outer portion;
stacking the frame inner portion, the frame outer portion, separators, anode assemblies, and cathode assemblies to capture the electrodes between the frame inner portion and the frame outer portion;
pressing the electrodes, the frame inner portion, and the frame outer portion;
forming an electrode stack by, while pressure is applied,
attaching the frame inner portion to the frame outer portion with the fingers to form a frame,
attaching the anode bus bars of the plurality of anode assemblies to form an anode conductor, and
attaching the cathode bus bars of the plurality of cathode assemblies to form a cathode conductor.
